(19) United States
(12) Patent Application Publication
(10) Pub. No.: US 2012/0103097 A1
(43) Pub. Date: May 3, 2012

(54) Flexible EMAT Arrays for Monitoring Corrosion and Defect Propagation in Metal Components and Structures

(76) Inventor: Borja Lopez Jauregui, Bedford, VA (US)

(21) Appl. No.: 12/915,256

(22) Filed: Oct. 29, 2010

(51) Int. Cl. G01N 29/04

(52) U.S. Cl. 73/643

(57) ABSTRACT

The invention pertains to the design, arrangement and fabrication of arrays of electromagnetic acoustic transducers (EMATs) for detection and monitoring of defects in metal components while they are being used in service. Emphasis is placed on printed circuit sensor coil designs that are attached to and covered with thin, flexible and insulating substrates. This laminated construction with additional means for electrical and thermal insulation, radiation heat shielding and simple cooling provides for consistent and reliable EMAT performance in monitoring components at elevated temperatures. The arrays include circular spiral coils, elongated spiral (racetrack) coils and rectangular spiral coils. Also described are arrays of dual-rectangular (butterfly) coils, meander coils and trapezoidal coils. Various assembly designs for the attachment of bias magnets are described.

### TECHNICAL FIELD AND BACKGROUND OF THE INVENTION

The field of this invention relates to the maintenance of structural and fluid transmission components in industrial facilities, naval vessels and gas and liquid transportation infrastructure by continuously monitoring the propagation of corrosion and certain defects in these structures. Specific applications include the measurement of wastage corrosion in pipe elbows, corrosion at the base of storage tanks, internal fissures in pressure vessels and stress corrosion cracks in and near various welds.

These applications are performed by attaching an array of EMATs to the test component and periodically transmitting, receiving, detecting and processing of reflections of ultrasonic waves. The time of flight and in some cases the amplitude of the reflected waves provides a measure of the extent of defect propagation. Also, a comparison of the immediate, reflected ultrasonic wave signal response to previous responses indicates the development of new defects since the last interrogation.

FIG. 1 illustrates the use of a conventional ultrasonic transducer to monitor corrosion on the opposite side of a steel plate. Conventional ultrasonic tests are performed primarily by piezoelectric transducers, 1, that generate compression and vertically polarized shear waves (SV-waves). When a short pulse of electrical energy is applied by a voltage source, e.g., 100 to 400 volts, to the electrical leads connected to the opposite side of the piezoelectric crystal, an ultrasonic compression wave is generated. The compression waves then propagate through a wave guide, 3, and acoustic coupling adhesive, 4, into the metal test component, 5. Reflections of the ultrasonic waves, 6, from the corroded surface of the test component travel back to the piezoelectric crystal through the waveguide. The reverse piezoelectric effect produces a signal response voltage between the electric lead terminals that is proportional to the transient pressure of the reflected P-wave. Measurement of the time delay between transmitted and reflected wave signals is the primary method of indicating the extent of component thickness loss.

If the temperature of the test component is greater than 45 C., a durable wave guide having low thermal conductivity, e.g. stainless steel, is used to protect the piezoelectric crystal. In cases where the test component temperature is greater than 100 C. the length of the wave guide is designed to be several inches long to assure the integrity of the piezoelectric transducer. Also, the adhesive located between the wave guide and test metal should be of sufficient integrity to maintain acoustic transmission and reception at these elevated temperatures for several months and even years.

The use of arrays of piezoelectric crystals with wave guides can be difficult, unreliable and expensive. Mechanical fixtures are required to hold waveguides in place and prevent loss of contact with the test component surface. Test component surfaces require careful preparation to assure couplant adherence throughout the duration of the test. The use of piezoelectric transducers that generate SH waves and measure the remaining thickness of a plate or pipe wall is in many cases not practical. If the adhesive couplant becomes fluid at elevated temperatures, little if any of the SH wave will be transmitted into the test component.

An electromagnetic acoustic transducer (EMAT) is an electrical device that generates and receives sound waves in electrically conducting materials, e.g., metals, without the requirement of physically contacting and bonding to the test material. Since sound waves reflect from metal-to-air boundaries, EMATs are frequently used as thickness measurement and inspection devices. Typical applications include measurement of thickness and detection of defects in metal components such as pipes, tubes, vessels, tanks, slabs and I-beams. For example, measurement of the extent of corrosion on the inside of a pipe can be accomplished by using a normal-beam EMAT to measure the remaining thickness of the pipe wall.

Horizontally polarized shear (SH) waves provide significant advantages in corrosion detection and measurement including shorter wavelength for a given frequency and greater penetration of columnar grain structures. Since SH waves can be transmitted and detected by piezoelectric transducers only if the wave guide is bonded or coupled to the test component through a viscous media, SH wave inspection with piezoelectric transducers at elevated temperatures is not practical. However, EMATs generate SH waves directly in the structure being tested without any coupling media. Also, EMATs can be constructed to withstand much greater temperatures, making it possible to measure thickness and defect size in test components that elevated temperatures. EMATs can be designed and fabricated with a low profile which eliminates the requirement for protruding mechanical fixtures to hold them in place on the test component. Furthermore, EMATs are much more versatile than piezoelectric transducers, since the focal point depth of the SH wave beam is easily adjusted by changing the excitation frequency.

Since EMATs generate sound waves immediately below the surface of the material being tested, they provide greater accuracy, reliability and repeatability for applications in which the material is contaminated, roughened or heated to elevated temperatures. EMATs can be constructed from materials that allow for inspection of metals at temperatures in excess of 1000 C. Since EMATs can be fabricated with a high degree of precision, the EMAT or its components can be replaced with minimal variation in characteristics or performance. The inherently simple construction of EMATs provides for a nearly unlimited variety of designs to facilitate shaping, steering and focusing beams to achieve the desired acoustic effects.

EMATs are typically composed of two fundamental components, magnets and Coils of insulated electrical conductors. Either permanent magnets or electromagnets can used to produce magnetic bias fields that penetrate the surface of the material component being tested. Coils composed of electrical conductors, commonly referred to as RF coils are placed between the magnets and the test material. These RF coils are used to induce high frequency magnetic fields in the test material. Interaction between the fields from the magnet and the fields from the RF Coils produce forces within the atomic or molecular lattice of the test material. The forces vary in intensity and direction with time at frequencies equal to those of the current in the RF coils. The oscillating forces produce acoustic waves that typically propagate within the test material and away from the EMAT.

Illustrated in FIG. 2 is an EMAT configuration that is used to generate and detect horizontally polarized shear waves that oscillate in a radial direction from said coil center and propagate away from the EMAT and into said test component in a direction that is normal, i.e., perpendicular to said test component surface, 5. A magnet, 7, produces a magnetic field that is also normal to the metal part under test. A spiral coil, 9, composed of insulated electrical conductors is energized through lead wires, 11, and soldered connections, 10, by an electrical power source. This results in alternating current which flows in said coil between its terminals.

Said alternating current produces alternating fields that encircle the currents and penetrate the surface of said test component. The penetrating fields induce alternating eddy currents in and near the surface of the test material. Alternating magnetic fields which encircle the eddy currents are generated in the test component. Said alternating fields caused by said eddy currents interact with said fields from said magnet to produce forces commonly referred to as Lorentz forces, in the test material and under each electrical conductor of the spiral coil, 9. Said forces result in sound waves, 6, which propagate from the EMAT and into metal that is under interrogation.

### SUMMARY OF THE INVENTION

The invention pertains to the design, arrangement and fabrication of various arrays of EMATs for detection and monitoring of defects in electrically conducting components such as metals while they are in service. EMAT arrays composed of novel sensor coils and magnet designs are used to generate bulk waves and guided waves in flat and contoured metal components. Bulk wave EMAT designs that can generate and detect horizontally polarized shear (SH) waves, vertically polarized shear (SV) waves and Compression waves are included. Also, EMAT designs for generating and detecting guided waves including, SH plate waves, Lamb type waves and Rayleigh (surface) waves are described.

Emphasis is placed on printed or etched circuit sensor coil designs that are attached to and covered with thin, flexible and insulating substrates. This construction provides for consistent and reliable EMAT performance in demanding production environments. The arrays include linear and two-dimensional (2-D) arrays of circular spiral coils, elongated spiral (racetrack) coils and rectangular spiral coils for generating and detecting radial polarized and linear polarized SH bulk waves. Dual-rectangular (butterfly) coils for generating and detecting linear polarized compression waves as well as linear polarized SH bulk and plate waves are described.

A salient feature of said printed circuit sensor coil designs is the plated-through hole in the flexible substrate. said plated through holes are used to connect multiple layers of concentric coils for increased sensitivity and resolution while maintaining a low profile for easy attachment to a test component and reliable performance in harsh environments. The multilayer construction afforded by said plated through holes also facilitates the design and fabrication of high density linear and 2-D Arrays for increased sensitivity and resolution. This configuration consists of an array of adjacent coils that are etched on one substrate and an array of overlapping coils that are etched on opposite sides of said substrate. Also, said arrays of coils can be insulated from each other by a cover layer and attached to form two arrays of overlapping coils. Using this construction, defects in the test components are interrogated with twice as many EMAT sensor coils. This results in an improvement in resolution and sensitivity by a factor as much as four over the single array design.

Various permanent magnet and electromagnet assembly designs are used to provide the magnetic bias fields for the each of the EMAT sensor coil arrays. Cylindrical magnets are linked together in flexible linear arrays or are molded to conform to the contour of the component under interrogation and are installed over the linear arrays of spiral coils to facilitate the generation of radial polarized SH waves. Block magnets are linked together in flexible linear arrays or are molded to conform to the contour of the component under interrogation and installed over the linear arrays of racetrack, rectangular or butterfly coils to facilitate the generation of linearly polarized SH waves. U-shaped magnets with opposite poles are linked together in flexible linear arrays and installed over the linear arrays of butterfly coils to facilitate the generation of linear polarized compression waves. Larger U-shaped magnets are used to induce magnetic fields that have a component that is parallel to the surface of the test component and to the electrical conductors of the EMAT coils.

EMAT arrays are designed and fabricated with coils, electrical connections and magnets that can withstand temperatures of the test component in excess of 600 degrees C. Copper coils are etched on thin sheets of insulating materials such as flexible ceramics. The coils are covered with electrical and thermal insulating sheets. The insulating sheets are covered with thin electrically conducting strips, e.g., metals, on the side that is opposite the coil to reflect heat radiation from the test component. Similarly insulating sheets coated with said strips are installed between the coils and magnets and connected to heat sinks to prevent the coils and magnets form reaching excessive temperature. Layers of ferromagnetic insulators can be installed between this thermally insulating sheet to prevent eddy current induction and resultant ultrasonic waves in the magnet poles.

### BRIEF DESCRIPTION OF THE FIGURES

FIG. 1 illustrates a piezoelectric ultrasonic transducer with a wave guide extension for monitoring corrosion in pipe.

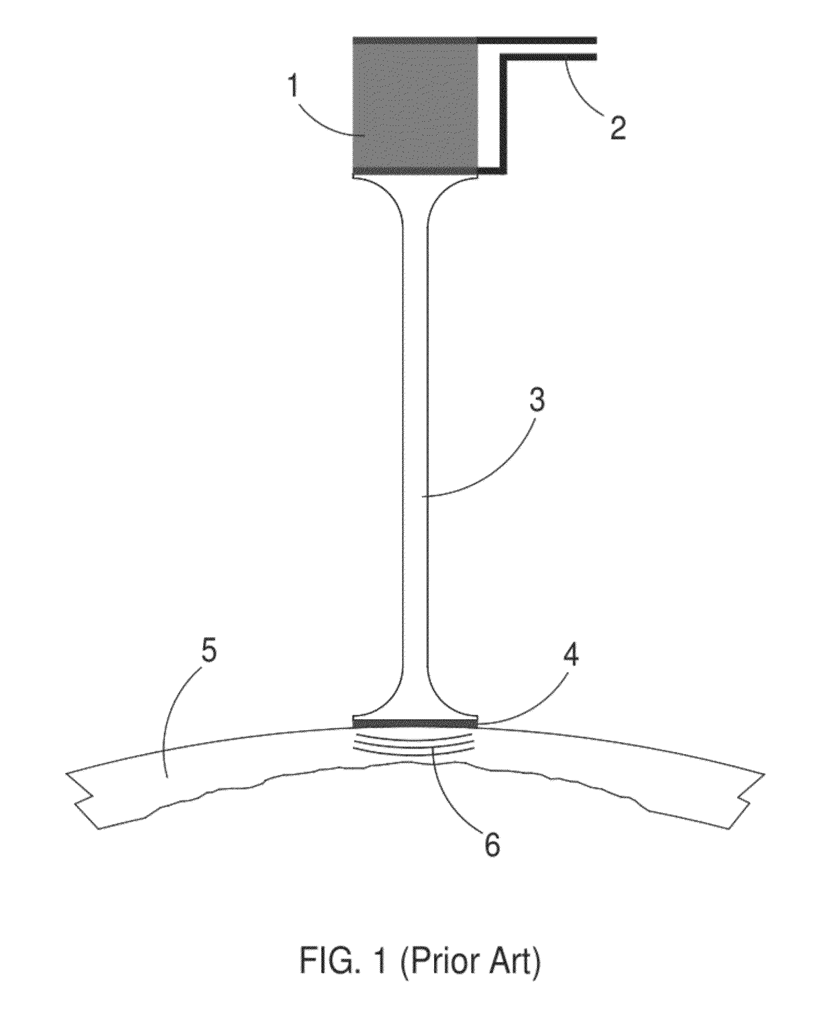

FIG. 2 illustrates a wire wound, circular spiral coil EMAT for monitoring corrosion in pipe.

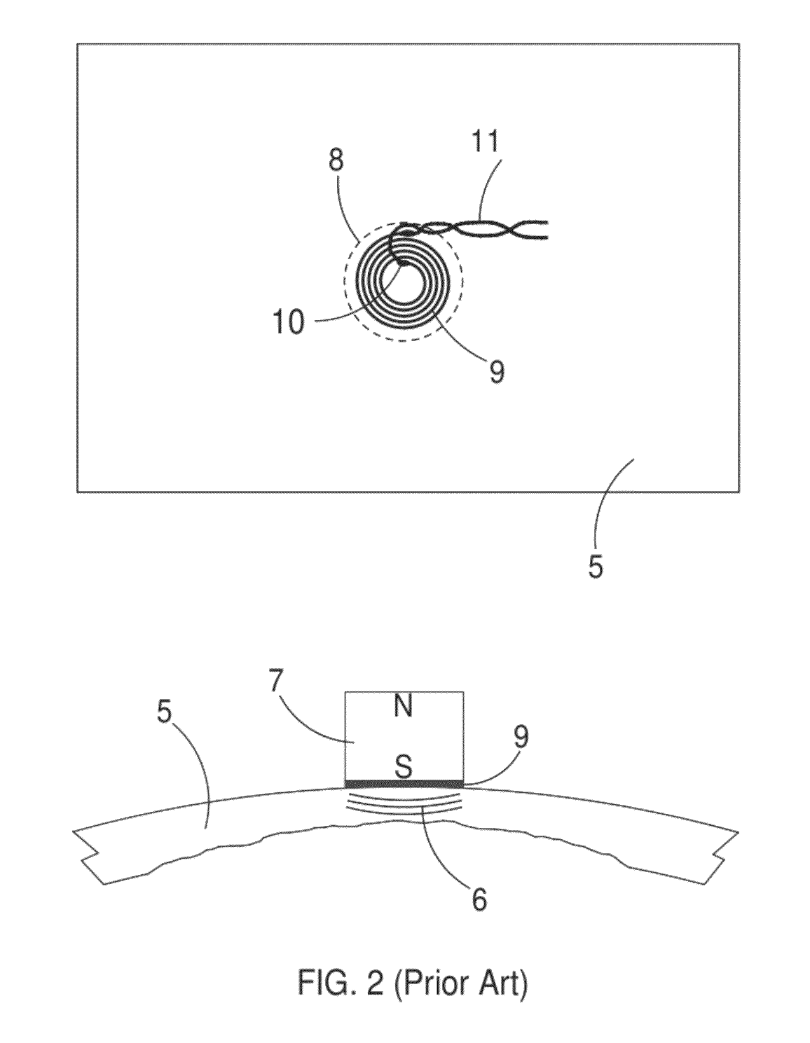

FIG. 3 illustrates a printed circuit or chemically etched, circular spiral coil EMAT for monitoring corrosion in pipe.

FIG. 4 illustrates a printed circuit or etched, racetrack coil EMAT for monitoring corrosion in pipe.

FIG. 5 illustrates a printed circuit or etched, rectangular spiral coil EMAT for monitoring corrosion in pipe.

FIG. 6 illustrates a printed circuit or etched, butterfly coil EMAT and block magnet for monitoring corrosion in pipe.

FIG. 7 illustrates a printed circuit or etched, butterfly coil EMAT and U-shaped magnet for monitoring corrosion in pipe.

FIG. 8 illustrates a printed circuit or etched, meander coil EMAT for monitoring defect propagation in pipes and plates.

FIG. 9 illustrates a printed circuit or etched, trapezoidal coil EMAT for monitoring defect propagation in pipes and plates.

FIG. 10 illustrates a linear array of printed circuit or chemically etched or machined, circular spiral coil EMATs for monitoring corrosion in pipe.

FIG. 11 illustrates a linear array of printed circuit or etched, racetrack spiral coil EMATs for monitoring corrosion in pipe.

FIG. 12 illustrates a linear array of printed circuit or etched, rectangular spiral coil EMATs for monitoring corrosion in pipe.

FIG. 13 illustrates a linear array of printed circuit or etched, butterfly coil EMATs and block magnets for monitoring corrosion in pipe.

FIG. 14 illustrates a linear array of printed circuit or etched, butterfly coil EMATs and U-shaped magnets for monitoring corrosion in pipe.

FIG. 15 illustrates a linear array of printed circuit or etched, meander coil EMATs magnets for monitoring corrosion in pipe and plates.

FIG. 16 illustrates a linear array of printed circuit or etched, trapezoidal coil EMATs and arrays of block magnets for monitoring corrosion in pipe and plates.

FIG. 17 illustrates a linear array of printed circuit or etched, overlapping circular spiral coil EMATs.

FIG. 18 illustrates a linear array of printed circuit or etched, overlapping racetrack coil EMATs.

FIG. 19 illustrates a linear array of printed circuit or etched, overlapping rectangular spiral coil EMATs.

FIG. 20 illustrates a linear array of printed circuit or etched, overlapping butterfly coil EMATs.

FIG. 21 illustrates a linear array of printed circuit or etched, overlapping meander coil EMATs for monitoring defect propagation in pipes and plates.

FIG. 22 illustrates the stratification of the EMAT coil construction indicating the component layers of insulation, electrical conductors and thermal conductors for the assembly of EMAT arrays that can withstand elevated temperatures.

FIG. 23 illustrates a linear array of articulated cylinder magnets for circular spiral coil EMATs.

FIG. 24 illustrates a linear array of articulated block magnets for racetrack coil EMATs.

FIG. 25 illustrates a linear array of block magnets encased in a slotted mold of flexible compound for circular spiral coil EMATs.

FIG. 26 illustrates a dipole magnet of rectangular crossection that is designed and fabricated to conform to the curvature of the component under interrogation.

FIG. 27 illustrates a U-shaped magnet that is designed and fabricated to conform to the curvature of the test component.

FIG. 28 illustrates an E-shaped magnet that is designed and fabricated to conform to the curvature of the test component.

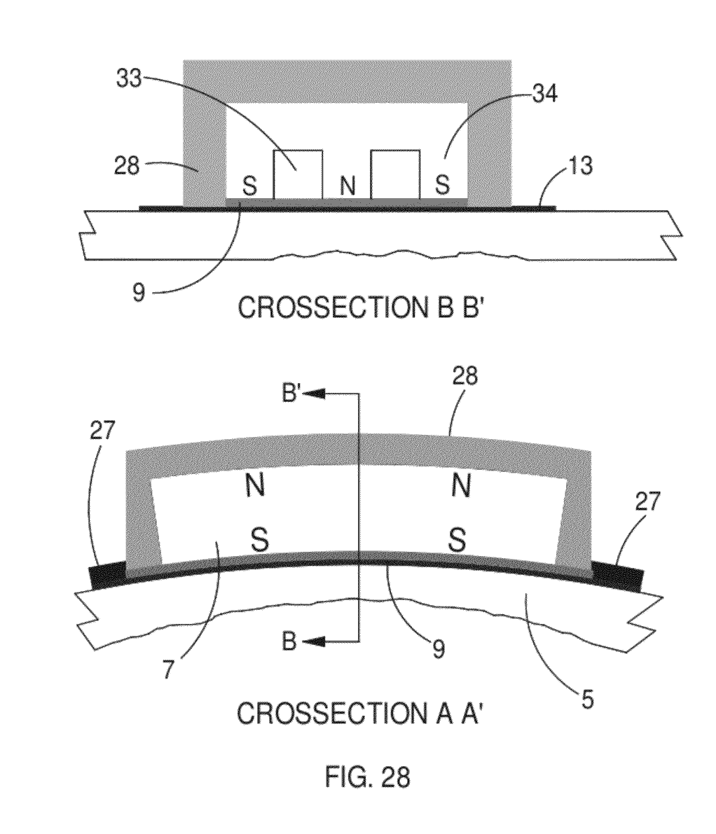

FIG. 29 illustrates a two-dimensional array of printed circuit or etched, circular spiral coil EMATs for monitoring defects in pressure vessel.

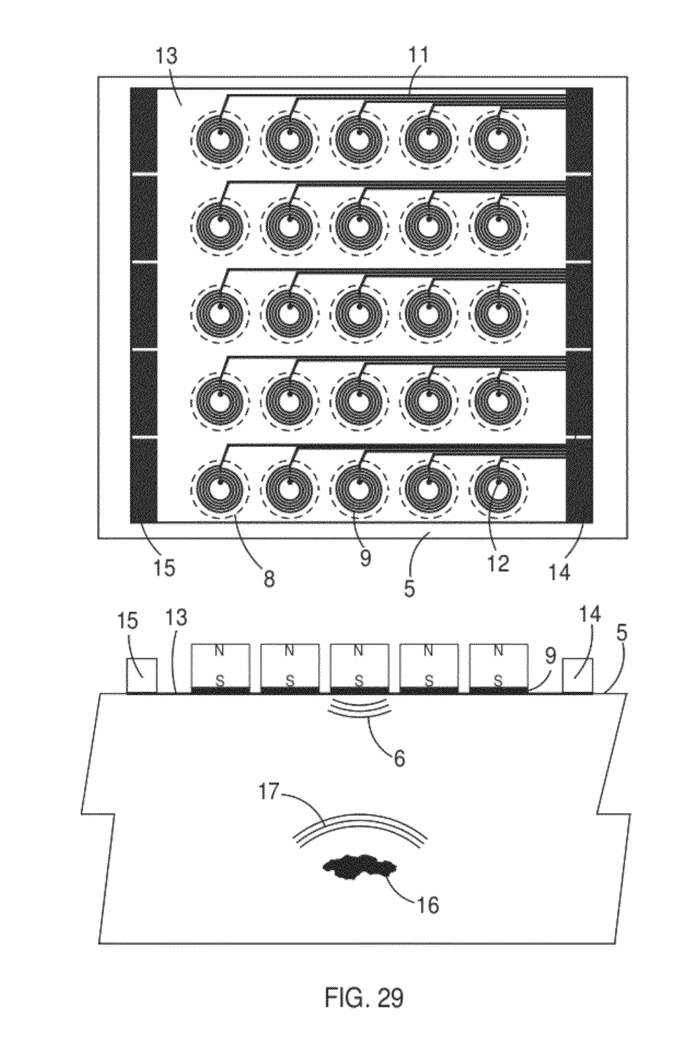

FIG. 30 illustrates a two-dimensional array of printed circuit or etched, racetrack coil EMATs for monitoring defects in pressure vessel.

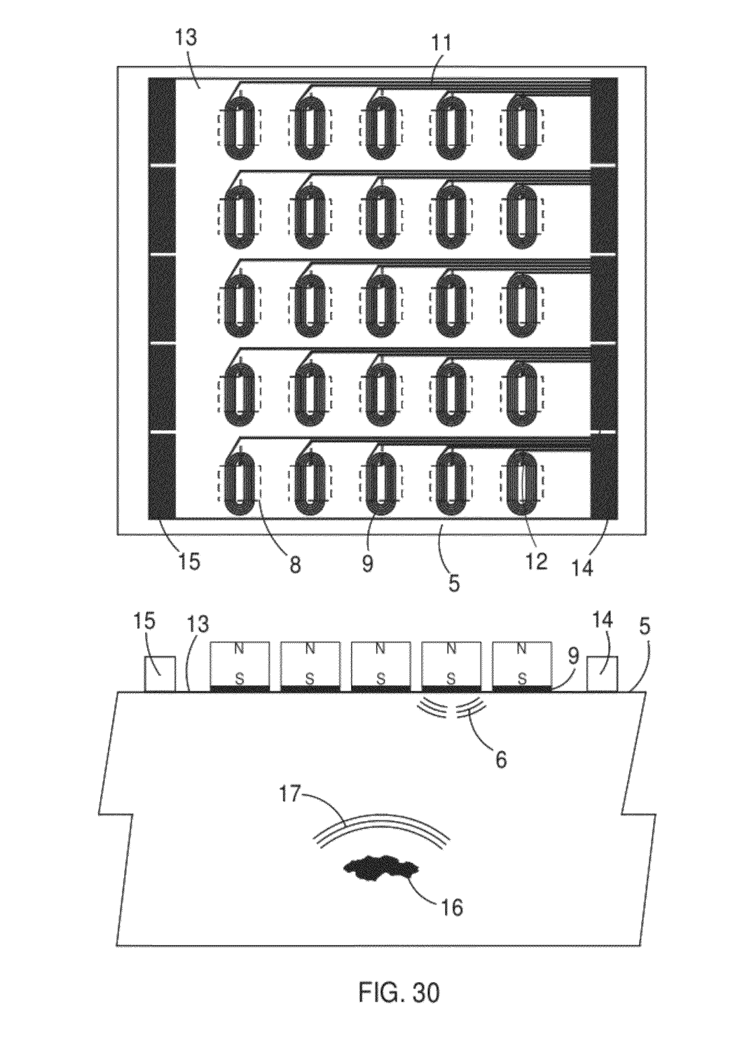

FIG. 31 illustrates a two-dimensional array of printed circuit or etched, rectangular spiral coil EMATs for monitoring defects in pressure vessel.

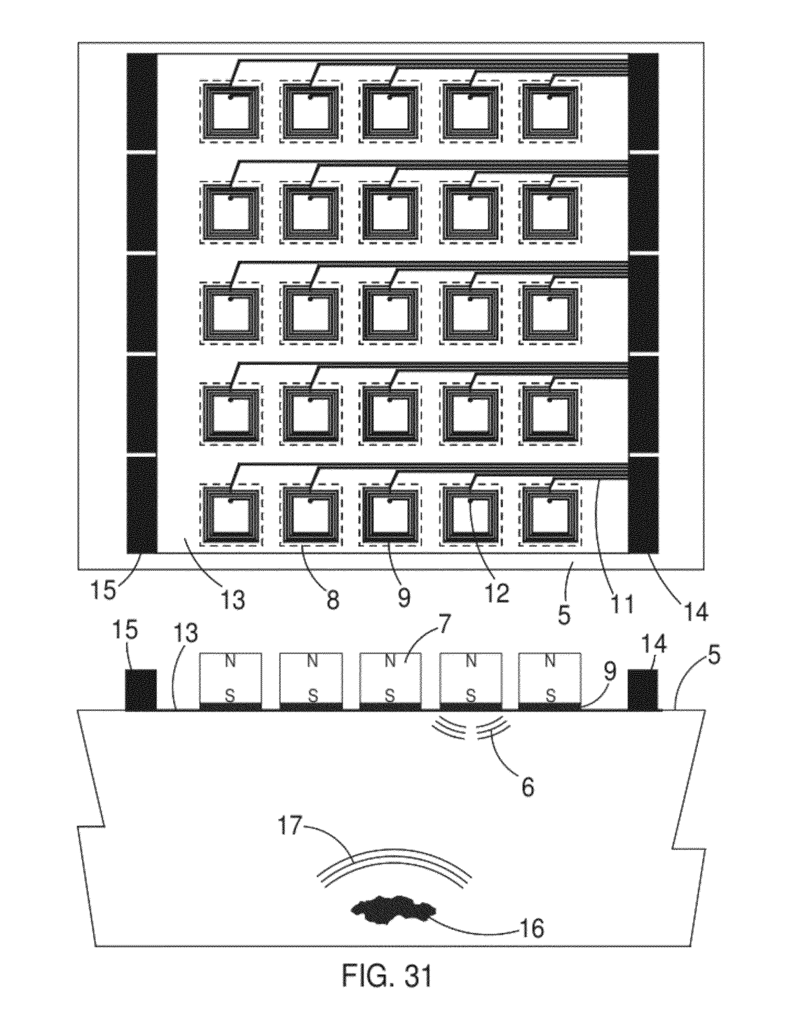

FIG. 32 illustrates a two-dimensional array of printed circuit or etched, butterfly coil EMATs for monitoring defects in pressure vessel.

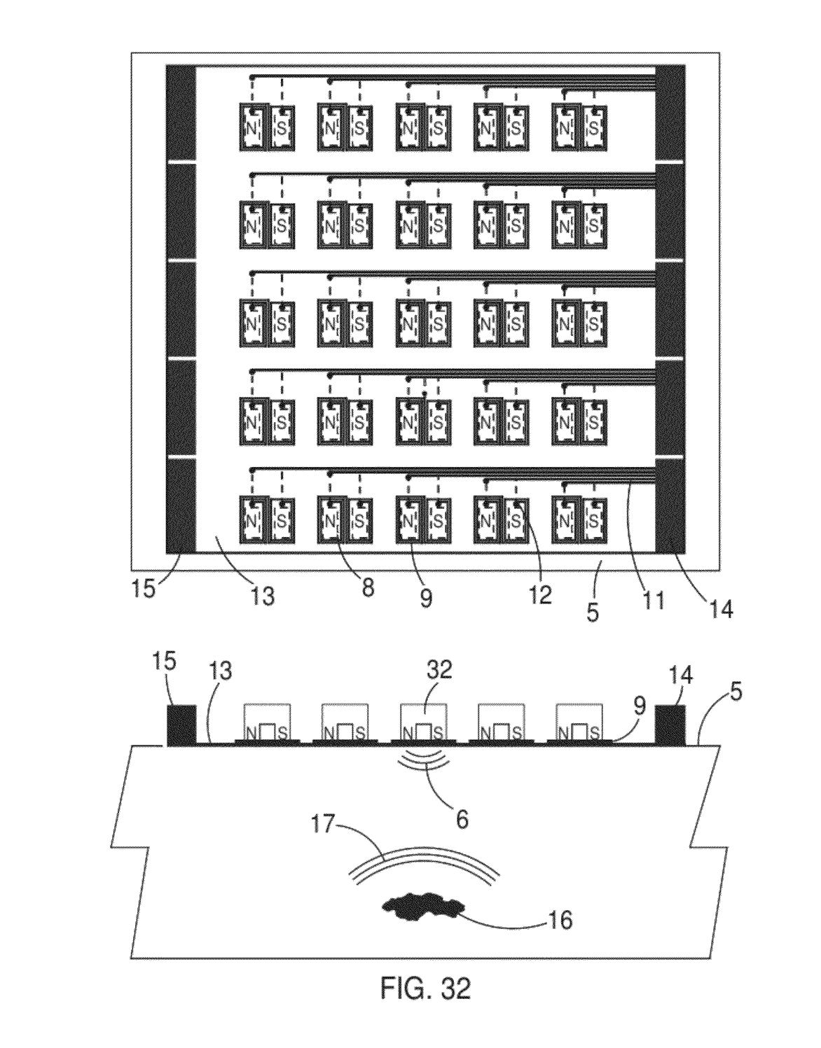

FIG. 33 illustrates a two-dimensional array printed circuit or etched, meander coil EMATs for monitoring defect propagation in pipes and plates.

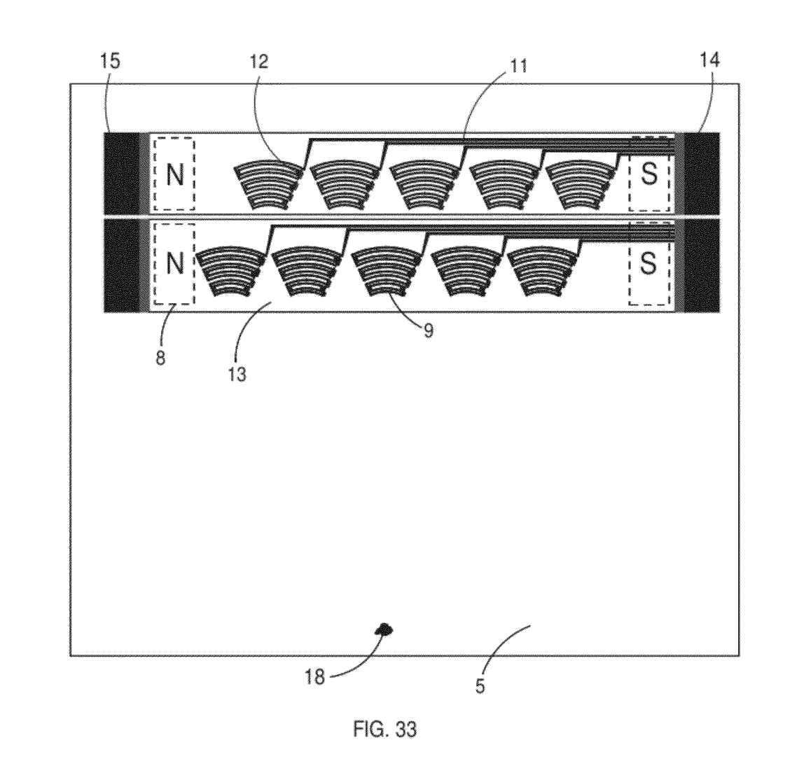

### DETAILED DESCRIPTION OF THE INVENTION

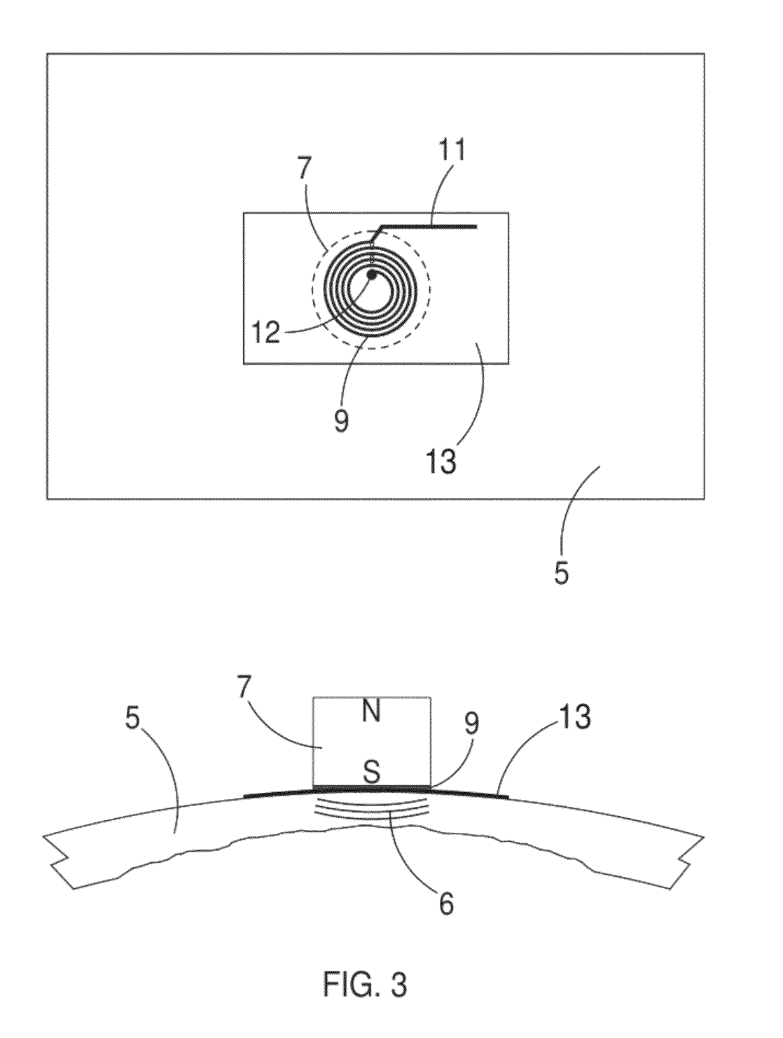

FIG. 3 illustrates an EMAT configuration that is used to generate and detect radial, horizontal-polarized bulk shear waves, 6, that propagate in a direction that is normal or perpendicular to the test component material, 5, surface. A magnet, 7, produces a magnetic field that is also normal to the metal part under test. A circular spiral coil, 9, is composed of insulated electrical conductors that are chemically etched or machined to from an electrical conducting plated coil that adheres to a substrate, 13, of insulating materials such as polyimides and ceramics. Said coils are placed in a position that is within the boundaries, 8, of the magnet poles.

Said circular spiral coil is composed of electrical conducting material including but not limited to copper, silver and gold. Said coils can be fabricated so that each coil consists of two or more layers where said coils in each layer are concentric to coils in the other layers. Said coils in each layer are electrically connected by plated holes, 12, through said substrate. Said substrate prevents electrical shorting between the coils in places other than the plated-through holes and provides resistance to heat transfer by conduction from said test component to said coil. Also, said plated-through holes improve the EMAT reliability and decrease fabrication cost by eliminating cumbersome, temperature-sensitive solder connections within and near to said spiral coil.

Electrical pulses applied to a pair of terminals, 11, generate alternating currents that flow between the terminals and through said spiral coils. These alternating currents induce eddy currents in said test components in the immediate vicinity of the coil. Said eddy currents in turn produce forces in the test materials in a radial direction with respect to the center of the coil. Said forces produce radial, polarized shear waves, 6, that propagate in a direction that is normal to the surface of the test component under interrogation, e.g., the pipe wall. The said shear waves reflect from the inside surface of the pipe, which is also referred to as the inside diameter (ID). Said shear waves return to the EMAT coil where they interact with the field from the magnet and induce a voltage that can be measured at the terminals of the coil.

The time delay between the excitation pulse and the reflected shear wave signal provides a measure of thickness of the pipe wall and therefore the extent of wastage corrosion at the position of the interrogating EMAT. A single electronic pulser and receiver amplifier can be multiplexed to acquire pipe wall thickness measurements under all sensor coils. Additional multiplexed receivers can be added to the instrumentation to acquire multiple reflections between adjacent EMAT coils. Said time delay between the multiple shear wave reflections is proportional to the average wall thickness between the transmitting EMAT and the adjacent EMATs. A decrease in said measured time delay compared to the previous measurement provides an indication of corrosion propagation.

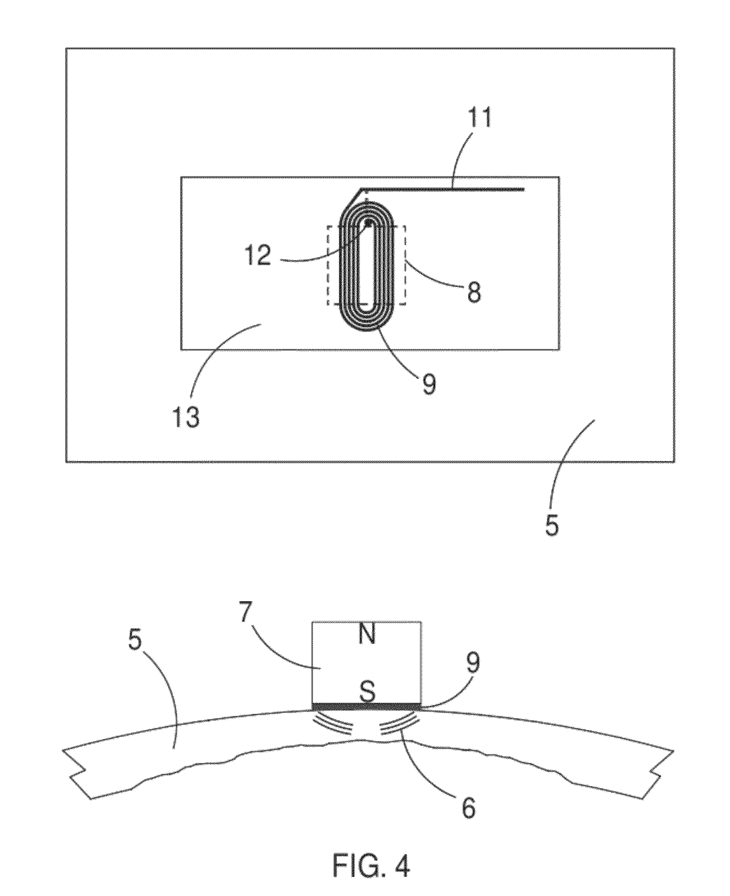

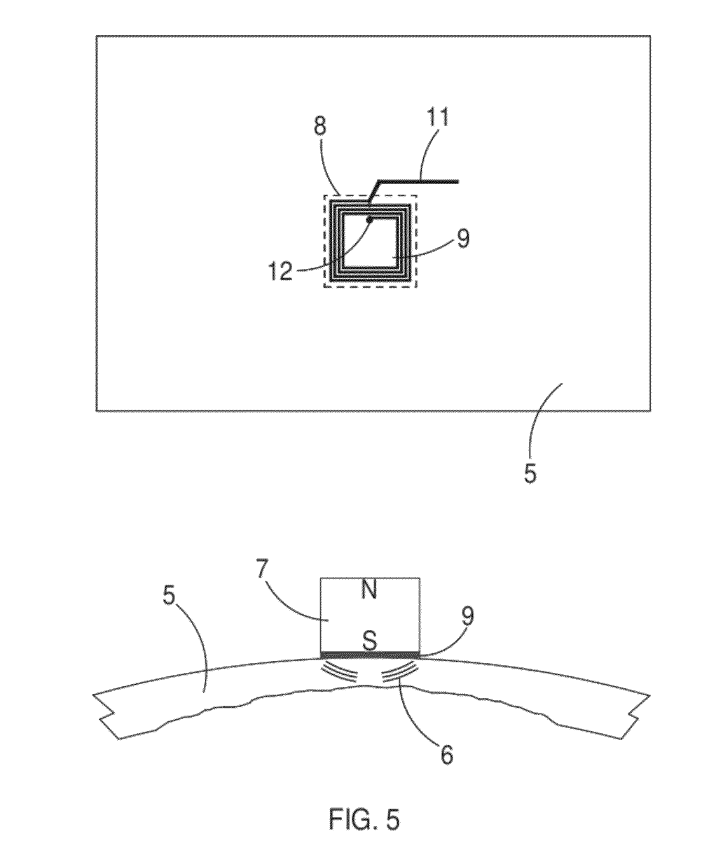

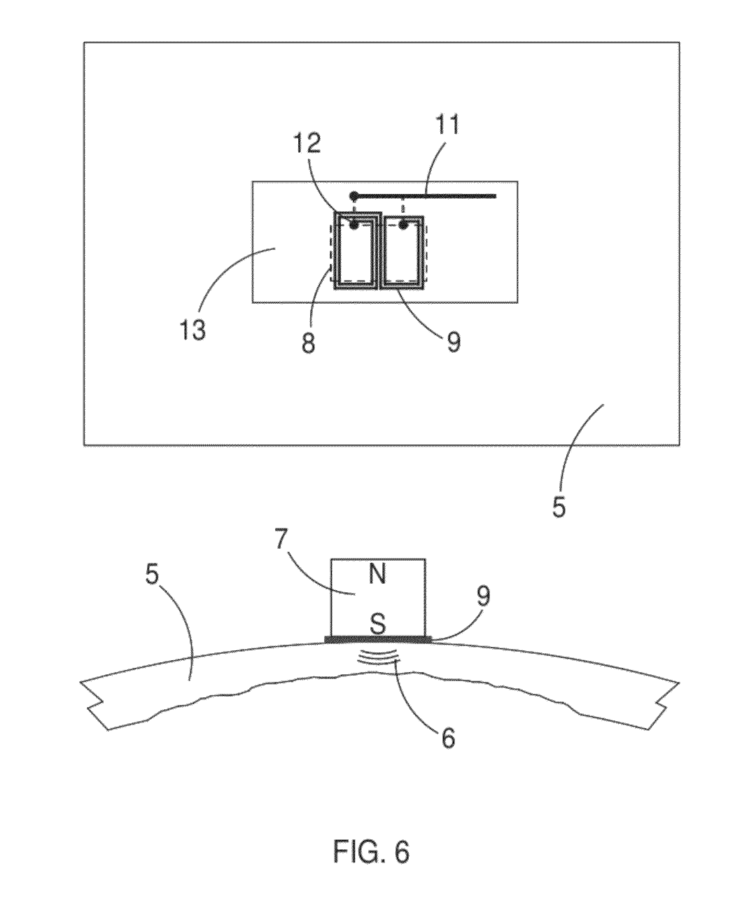

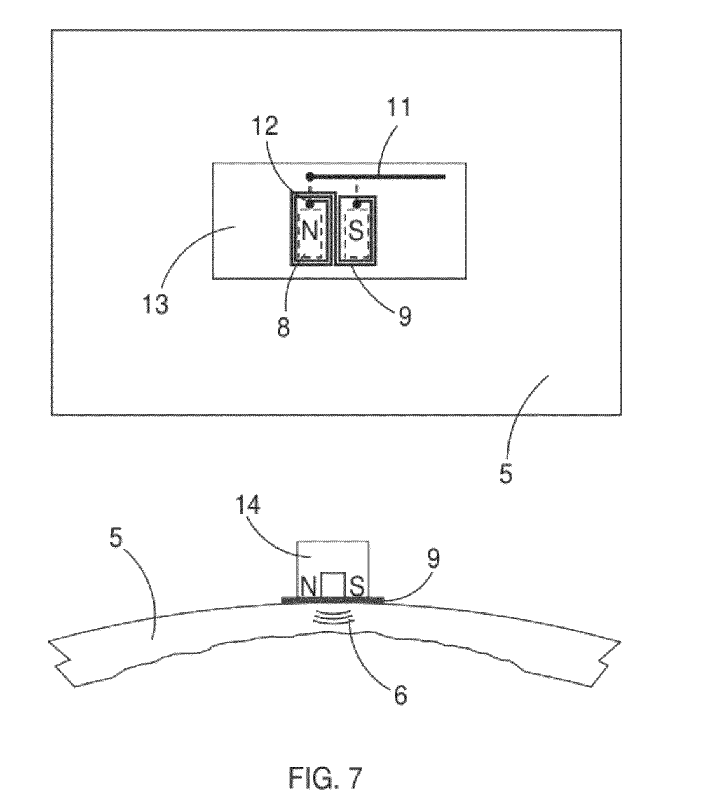

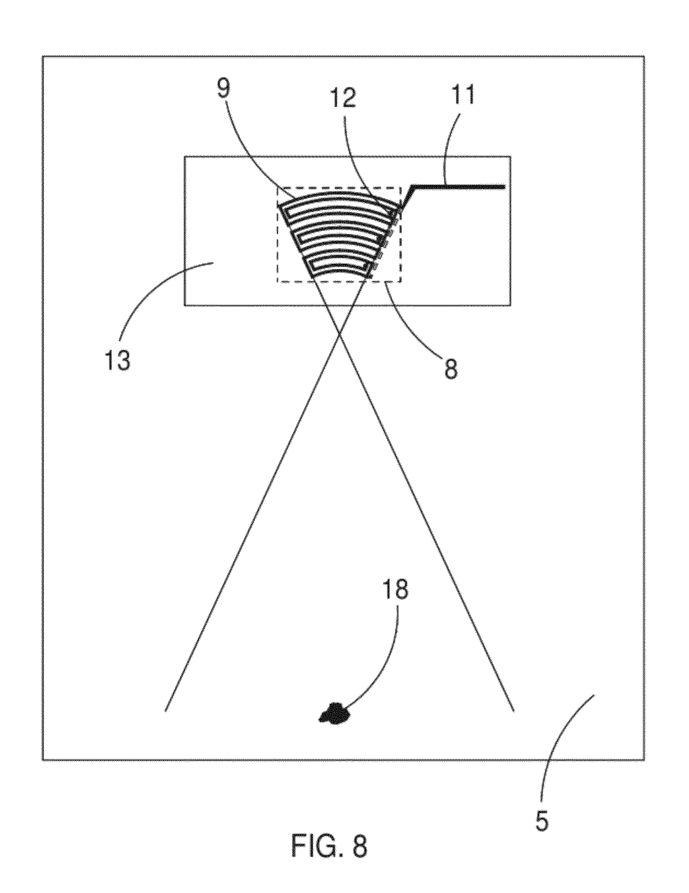

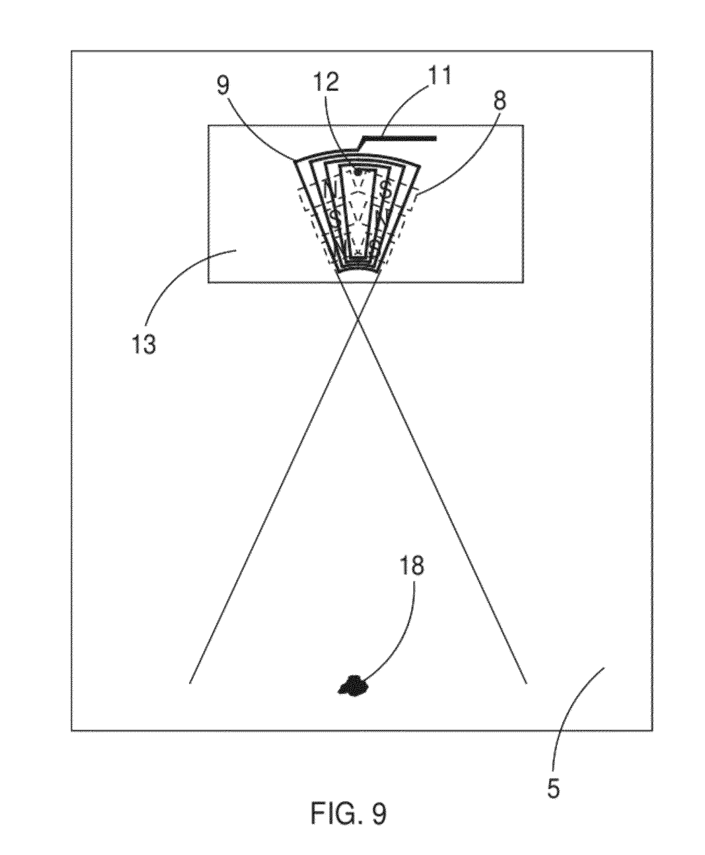

Said EMAT coils including the racetrack coil, FIG. 4, rectangular coil, FIG. 5, butterfly coil, FIG. 6 and butterfly coil FIG. 7 meander coil FIG. 8 and trapezoidal coil FIG. 9 have a similar construction as said circular spiral coil, FIG. 3. The primary differences in construction are the placement of the plated-through holes, 12, and the configuration and placement of the magnets. The configuration of the magnets for said circular spiral coil can be either a cylinder or a block where as the configuration used for said racetrack coil, said rectangular coil, said meander coil and said trapezoidal coil is a block. Another difference in the magnet configuration and placement for the butterfly coil is the block magnet, 7 in FIG. 6 and the U-shaped magnet 14 in FIG. 7. The placement of one of the poles of said block magnet over the straight, center sections of the butterfly coil windings, 9, as illustrated in FIG. 6, provides for the generation and detection of linearly polarized shear-horizontal (SH) waves. The placement of said poles of said U-shaped magnet, 14, between said straight, center sections of the butterfly coil provides for the generation and detection of linearly polarized longitudinal SH waves.

Another butterfly coil arrangement is used to generate SH waves that propagate at an angle with respect to the test material or in the case of plates and pipes to generate guided SH waves. This is accomplished by positioning said butterfly coils so that the straight sections of said butterfly coil are aligned and in close proximity to a straight section of an adjacent butterfly coil. Each of the said butterfly coils is connected in series to an adjacent butterfly coil in the linear array by the plated holes, 12, through the substrate, 13, so that the electrical current in adjacent conductors will flow in the came direction. The coils at ends of the linear array are connected to parallel strips of conductors that are separated and insulated from each other by said substrate. Said pair of conductor strips is connected to a connector at the end of said linear array.

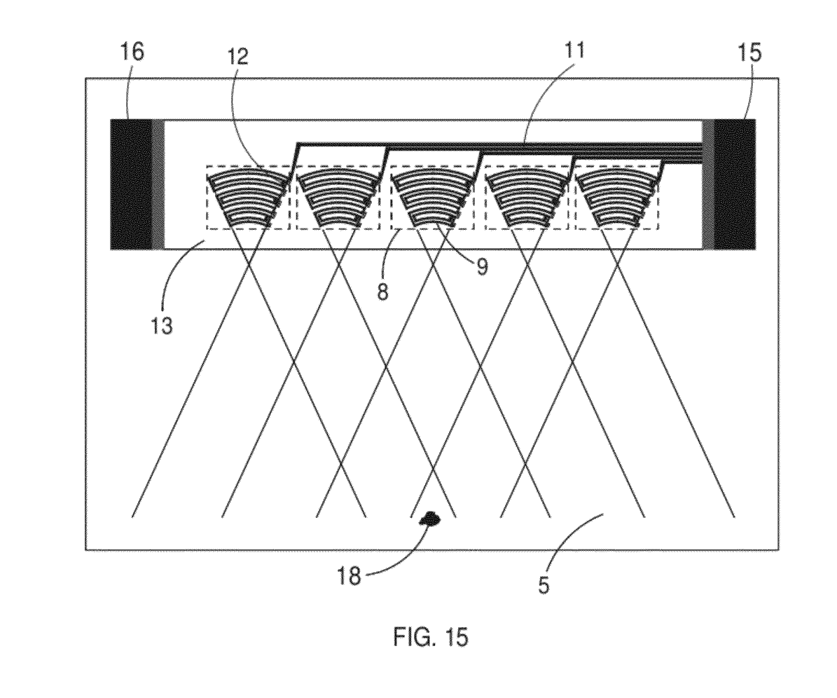

Generation and detection of said SH waves that propagate at an angle with respect to the test component surface is accomplished by placing block magnets, 7, as illustrated in FIG. 15, over the said straight sections of said coils so that the magnetic field is perpendicular to the test component surface. Said magnets are oriented with their poles in opposite polarity to the poles of an adjacent magnet. When the said linear array of butterfly coils is excited by an alternating current, eddy currents are induced near the surface of test material in a direction that is parallel to said straight sections of said butterfly coil array. Interaction between the alternating fields surrounding the eddy currents and the static field of said block magnets produces SH waves that are perpendicular to said straight sections of said butterfly coils.

Said SH waves having the same polarity are generated in the test material under each straight section. Said sections can be combined to form an initial SH wave front that is approximately equal to the length of said linear butterfly coil array. Said sections of linear butterfly coil arrays can assemble in parallel to form a SH EMAT phased array. Also the sections of the linear array can be shaped in approximately circular sections to form a focused phased array.

FIG. 8 illustrates meander coil EMAT that is composed of two or more elongated coils that are connected in series. Said meander coil is formed by etching or machining two rectangular or racetrack coils on each side of the substrate, 13. The pairs of coils are connected so that the electrical current in the parallel conductors in the central portion of the butterfly coil flows in the same direction. Each meander coil consists of electrical conducting material including but not limited to copper, silver and gold. Said meander coils can be fabricated so that a coil consists of two or more layers. Each coil in each layer is concentric to one or more coils in the other layers. Said coils are electrically connected by plated holes, 12, through the substrate.

A two-pole magnet, 7, illustrated in FIG. 4 and FIG. 5, produces a magnetic field that is normal to the surface of the test component and covers the entire meander coil. This configuration provides for generation and detection of vertically polarized shear waves that propagate in the test component in two directions, toward the defect, 18, and in the opposite direction from said defect. If the test component is a plate, pipe or component that has a wall thickness less than 20 mm, a Lamb wave can be generated and detected by said meander coil configuration.

Surface waves or Rayleigh waves can be generated and detected by electronically tuning said meander coil and adjusting the frequency of the excitation current to produce a surface wave of maximum amplitude. If the test component material is ferromagnetic and has the physical property of magnetostriction, said meander coil can be used to generate and detect horizontal, polarized bulk shear (SH) waves. Generation of SH waves requires that the magnetic bias field is parallel to the surface of test component and directed at an angle between zero and 55 degrees with respect to the conductors in the central part of said meander coil.

FIG. 9 illustrates a Lorentz EMAT that is used to generate focused SH waves metals that may not have magnetostriction properties. Said EMAT is composed of trapezoidal shaped coil, 9, covered by an array of block magnets, 8, that have alternating polarity. Said meander coil is formed by etching or machining two trapezoidal shaped coils on each side of the substrate, 13. The pairs of said trapezoidal coils are connected so that the electrical current in the parallel and adjacent conductors in the central portion of said coils flows in the same direction. Each said coil consists of electrical conducting material including but not limited to copper, silver and gold. Said meander coils can be fabricated so that a coil consists of two or more layers. Said coil in each layer is concentric to the coil in the other layer. Said coils are electrically connected by plated holes, 12, through the said substrate.

An array of block magnets, 8, is arranged so that said magnets alternate in polarity and are positioned over the straight sections of the coil windings. Lorentz forces having alternating polarity are generated buy interaction of the eddy currents with the magnetic fields from each of the said poles. Said forces are directed at an angle of approximately 90 degrees with respect to the conductors under the magnet poles. This configuration provides for generation and detection of SH waves that propagate in the test component in two directions, toward the defect, 18, and in the opposite direction from said defect. Said block magnets are installed at an angle with respect to the center axis of the said coil so that said SH waves are focused in the direction of said defect. If said test component is a plate, pipe or component that has a wall thickness less than 20 mm, an SH plate wave can be generated and detected by said trapezoidal coil.

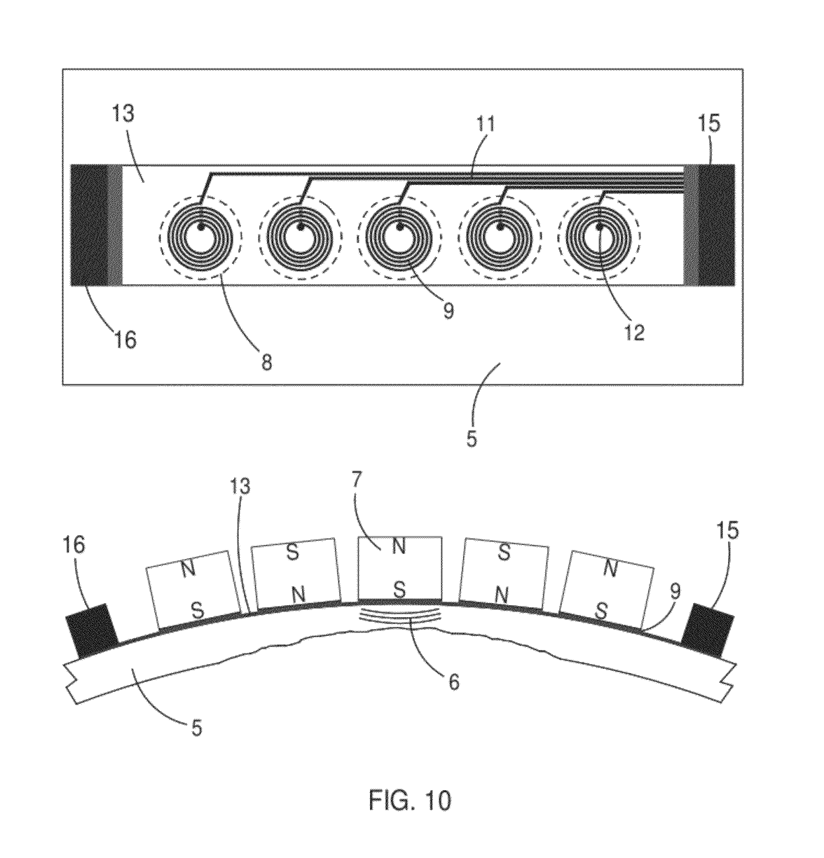

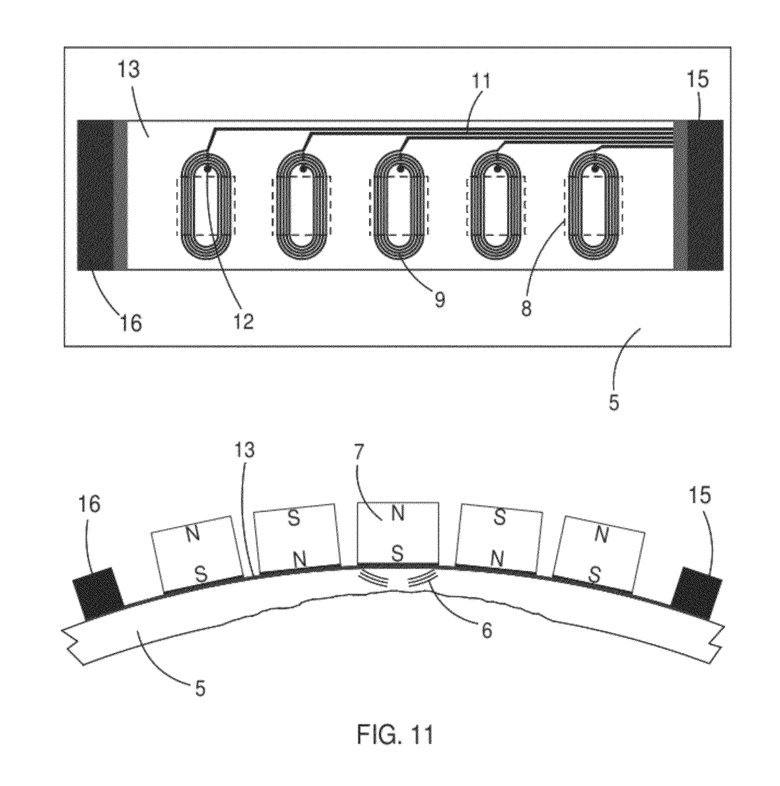

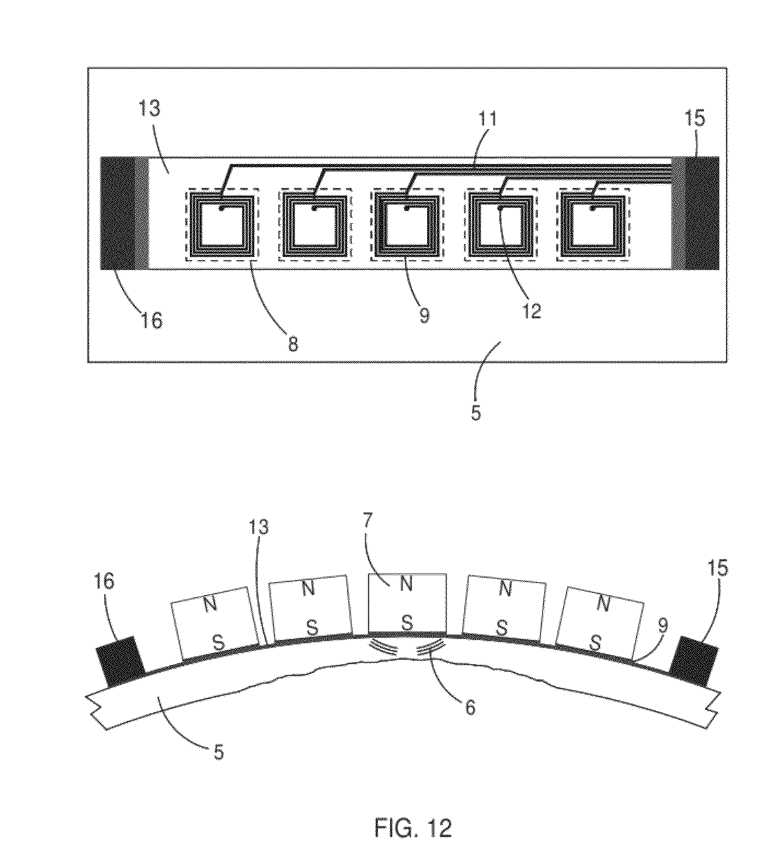

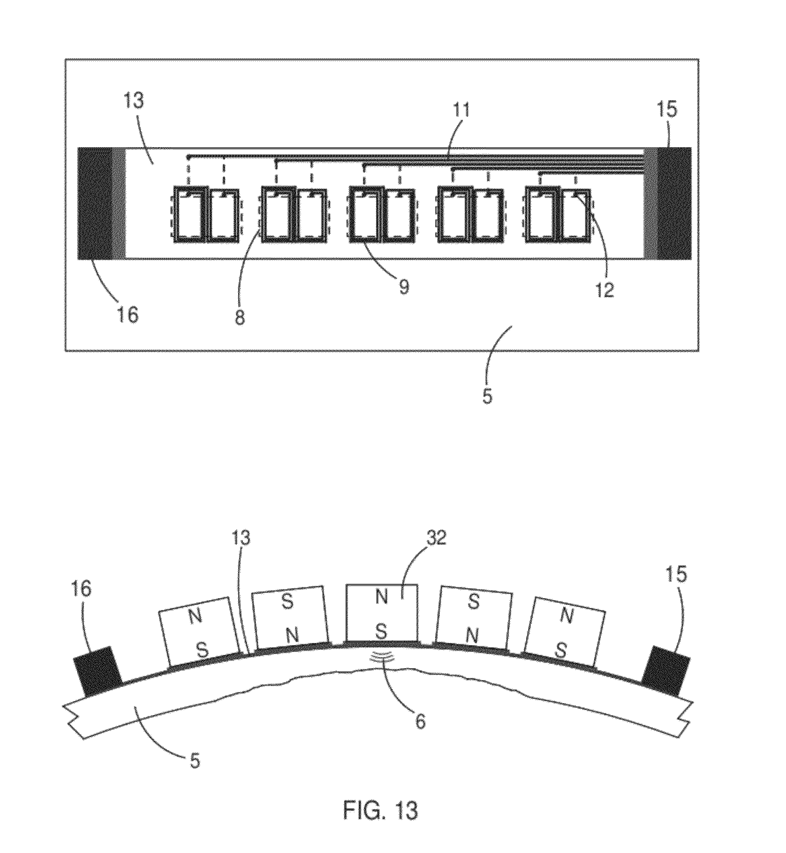

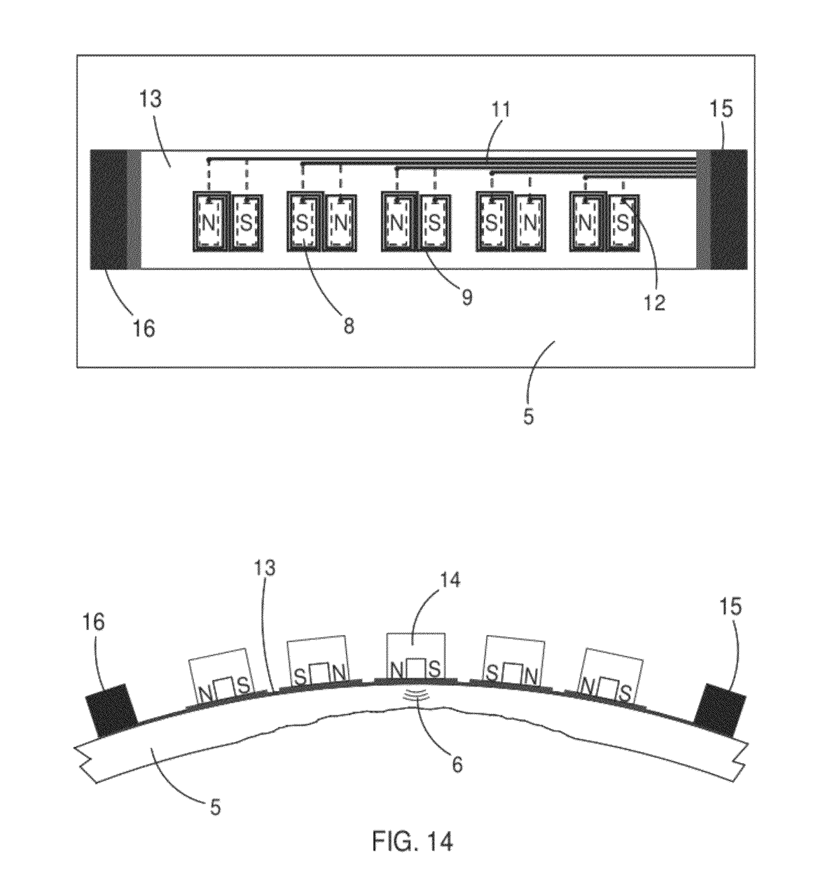

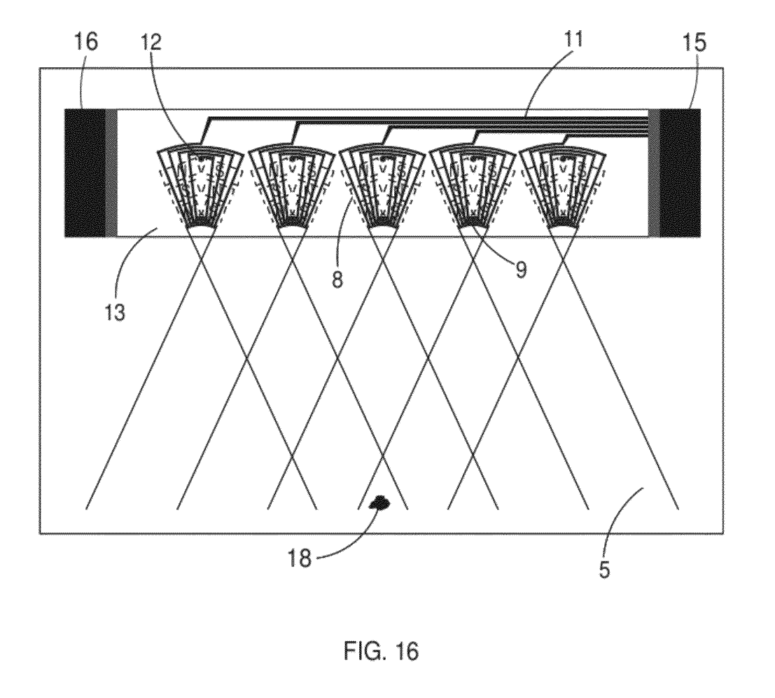

A linear array of circular-spiral-coil EMATs is illustrated in FIG. 10. The printed circuit coils, 9, are composed of two layers of conductors arranged in a concentric spiral. Said coil layers are electrically connected by plated holes, 12, through the substrate. Said overlapping pairs of electrical leads, 11, to each coil and are attached to the connector, 15, that is thermally and electrically insulated from said test component. One of the poles of a two-pole magnet, 7, is placed over each of the spiral coils in an area indicated by the dashed lines, 8 in the top view of FIG. 4. The magnet poles alternate in polarity so that the shape and intensity of the magnetic field under a given pole is improved by adjacent magnets. Similar designs and constructions for said linear arrays of said racetrack coils, said rectangular coils, said butterfly coils with block magnets, said butterfly coils with U-shaped Magnets, said meander coils and said trapezoidal coils are illustrated in, FIG. 11, FIG. 12, FIG. 13, FIG. 14, FIG. 15 and FIG. 16 respectively.

Said circular spiral coils, said racetrack coils, said rectangular coils, said butterfly coils, said meander coils, said trapezoidal coils are positioned concentrically to each other and connected to individual lead wires in a configuration so that the electrical currents in the adjacent conductors are in the same direction. As a result the magnetic fields produced by each said conductor are in the same direction at each corresponding segment of the coil. This positioning of corresponding coil segments produces a constructive interfere of the magnetic fields to form a magnetic field of greater intensity than the magnetic field of any of the said coils on one side of said substrate. The electrical lead, 11, to the top layer coil, i.e., the coil farthest from the test component, is placed over the electrical lead to the bottom layer coil, i.e., the coil closest to the test component. This provides for a compact arrangement of multiple leads that is beneficial to the application of the EMAT arrays. Also, this construction of said conductor leads, results in minimum electrical inductance as observed at said connector terminals for maximum-resolution, thickness measurements.

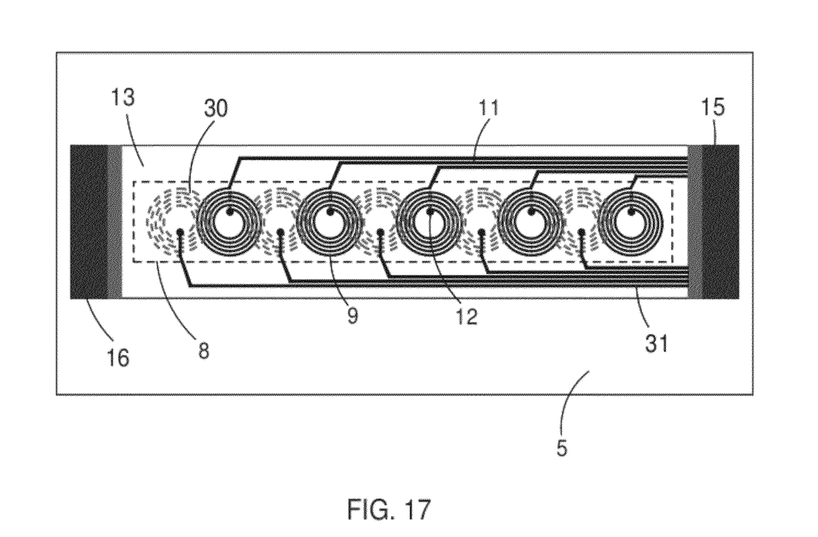

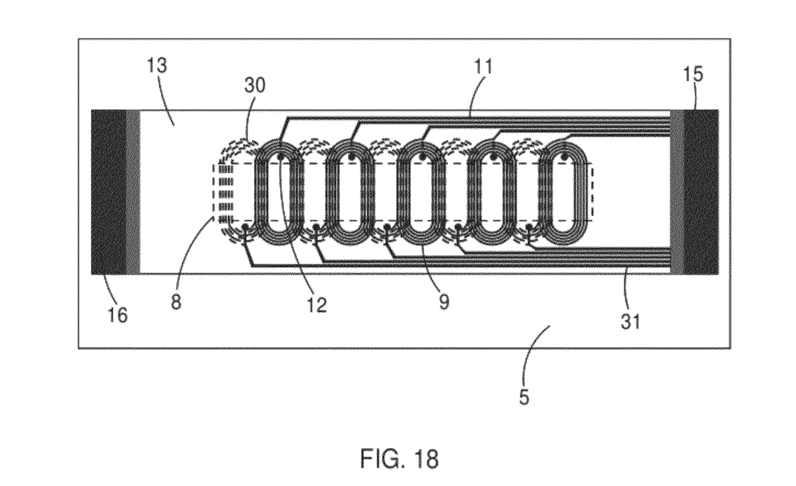

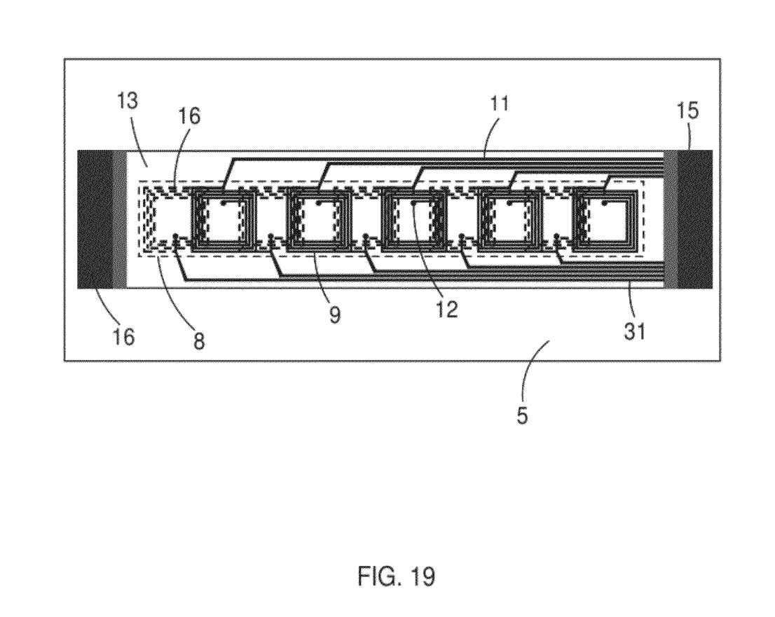

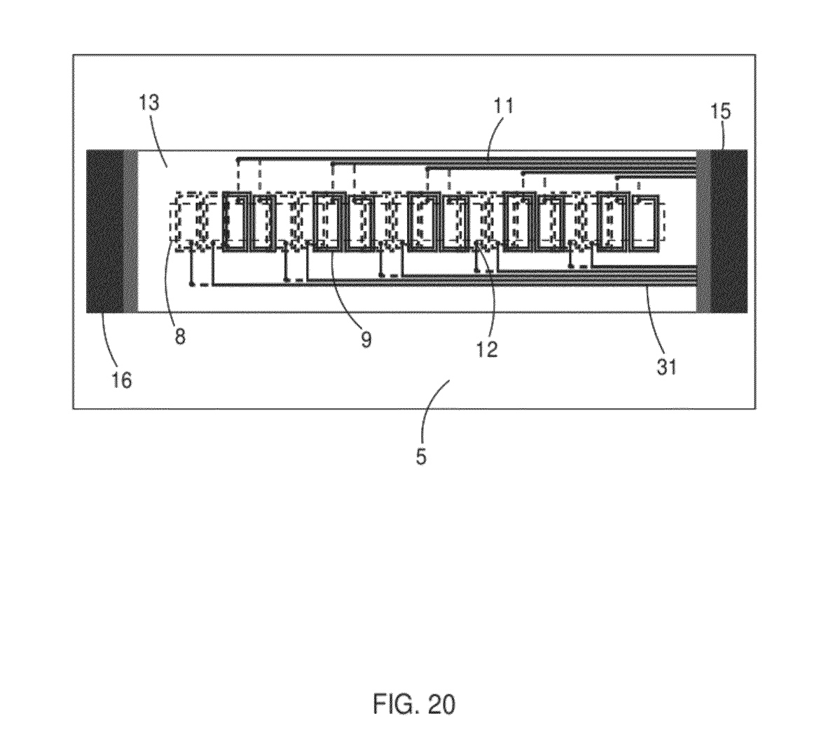

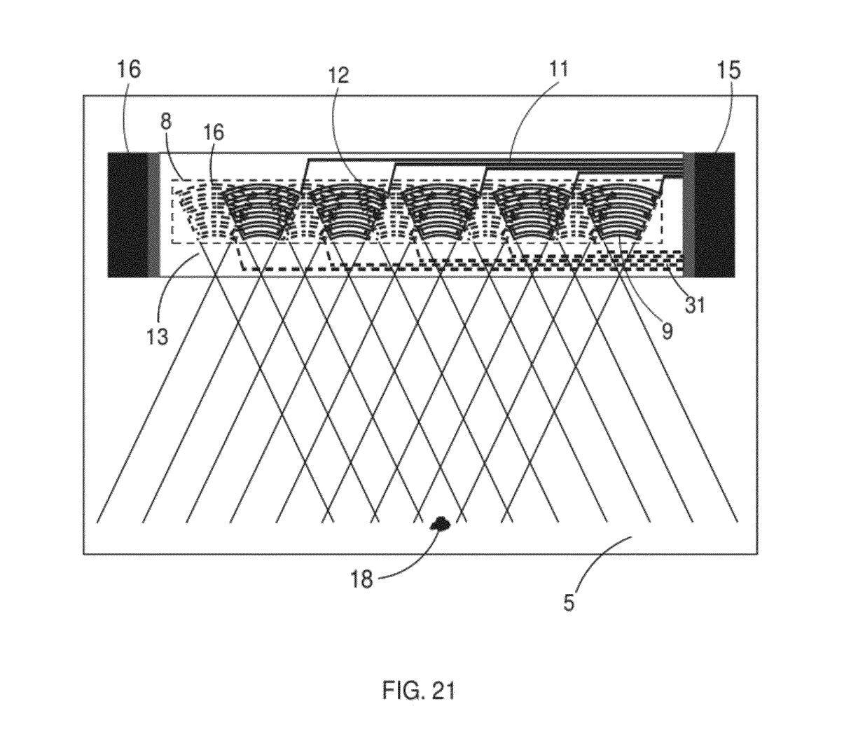

FIG. 17 illustrates a linear array of printed circuit or etched, overlapping circular spiral coil EMATs forming a greater density of EMATs that exhibits greater resolution and coverage compared to the separated EMATs illustrated in FIG. 10. This arrangement of EMAT coils is composed of two collinear arrays of said coils, one on each side of the insulating substrate. Each said coil has a separate lead conductor on each side of the said substrate. One lead is connected to the coil conductor on the greatest coil radius while the other lead is connected through the plated hole, 12, on the minimum radius of the coil. The ends of the coils merge into parallel strips of conductors, 11 and 31 that are separated and insulated from each other by the substrate, 13. Each of the said parallel, pairs of electrical leads forms a transmission line to the connector, 14, that has decreased electrical inductance and impedance compared to conventional coaxial and twinaxial cables. Similar designs and constructions for said overlapping linear arrays of said racetrack coils, said rectangular coils, said butterfly coils, said meander coils and said trapezoidal coils are illustrated in, FIG. 18, FIG. 19, FIG. 20, and FIG. 21 respectively.

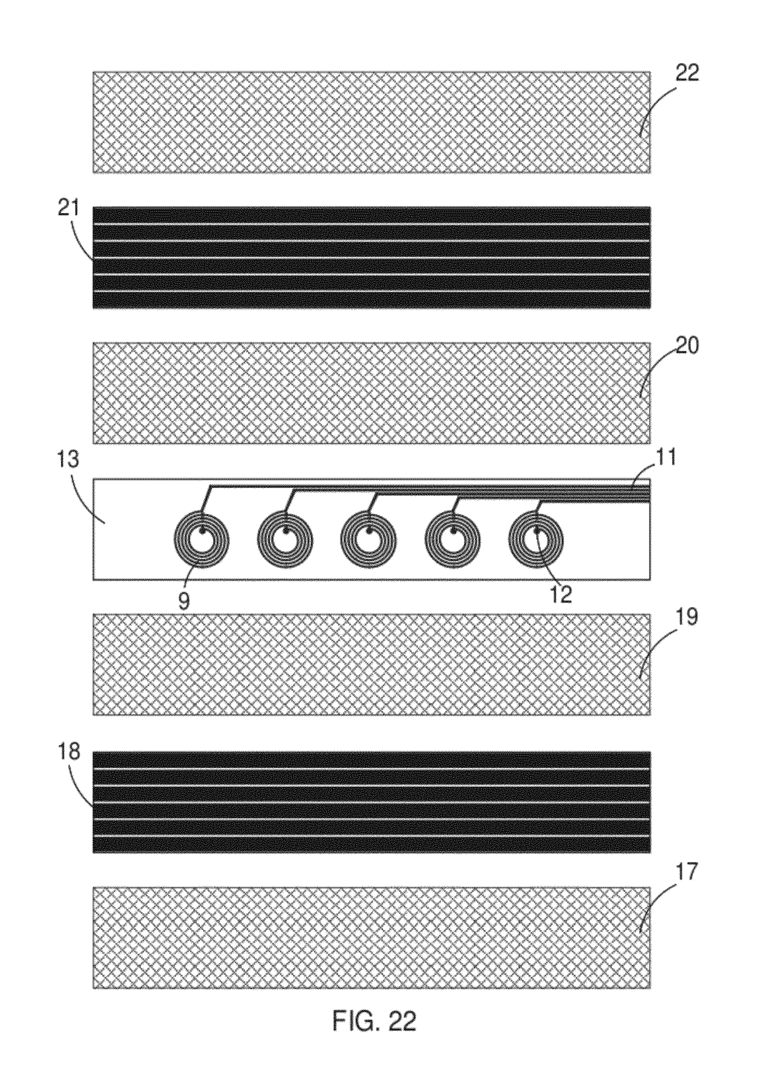

FIG. 22 illustrates the basic design and construction of said typical EMAT coil array. The coil substrate, 13, is composed of electrical insulating materials that maintain their physical and electrical properties at elevated temperatures including but not limited to polyimides and ceramics. Said cover layer, 17, that is closest to the test component under interrogation is composed of electrical and thermal insulating materials including but not limited to polyimides and ceramics. Said cover layer adds resistance to the flow of heat from the said test component to the coils and magnets thereby reducing said coil and magnet temperature. Cover layer, 18, is composed of strips of electrical conductors that are insulated from each other. Said conductor strips provide a thermal radiation shield that reflects heat radiation from the test component. Said strips are insulated from each other to limit the eddy current shielding of the relatively low-frequency electromagnetic fields from test component material. Said conducting strips can be connected to heat sinks at the ends of the said coil array such that part of the heat from said test component is guide away from the coils and magnets thereby reducing the temperature of said coils and magnets. Cover layer, 19, serves as electrical insulation between said conductor strips and said coil array as well as additional thermal insulation between said coils and test component.

Cover layer, 20, provides electrical insulation between said coils and layer, 21, as well as thermal insulation between the magnets and the test component. Layer, 22, is composed of strips of electrical conductors that are insulated from each other. Said layer 20 provides a thermal radiation shield between the magnets and the test component. Also, when said conducting strips of said layer are connected to heat sinks such as Peltier coolers at the ends of the said coil array part of the heat of conduction from the said coils and is guide away from the magnets thereby reducing said magnet temperature. Layer 22 provides electrical and thermal insulation between layer 21 and the magnets.

Said EMAT coil layers can either be flexible so that said array conforms to the surface to the test component by mechanical means or can be composed of materials that are cast into a shape that closely matches the contour of said test component. When said test component is a pipe, either flexible or conforming EMATs can be held in place on the pipe surface by extending the length of the substrate and the cover layer so that the ends the composite structure can be pulled in tension and fastened together at a convenient distance from the EMATs. Also, said EMAT array ends can be attached to a belt that performs the same function of attachment to the test component.

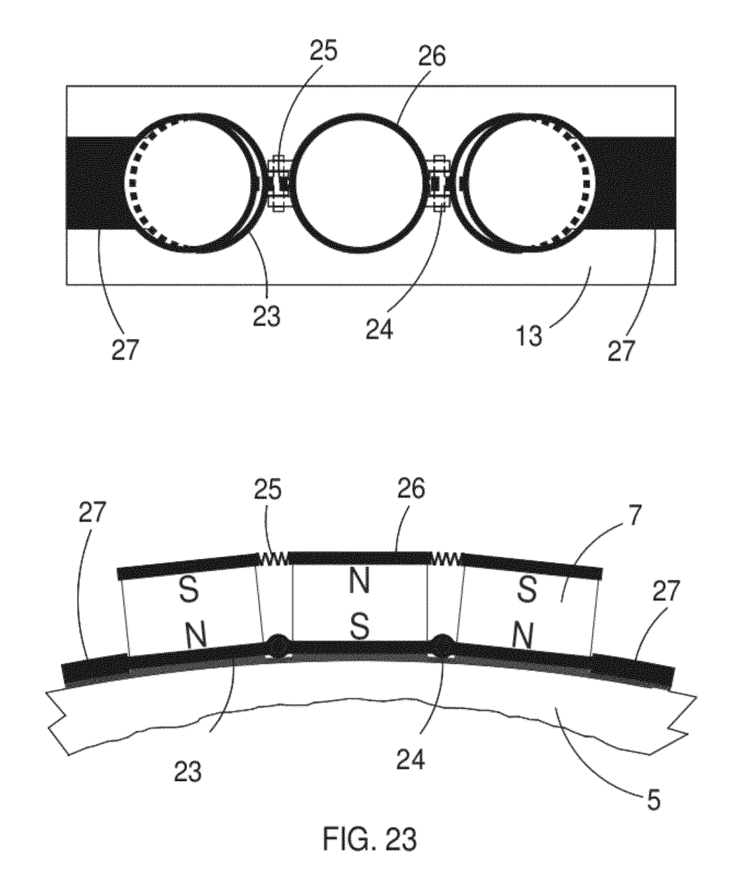

The magnets which provide the magnetic bias fields for acoustic wave transmission and reception must maintain close proximity and center position over the EMAT coils during the monitoring process. One method of achieving this is by a simple chain of hinged rings as illustrated in FIG. 23. The rings, 23, and hinges, 24, are installed near the base of the magnet poles that are close to the coils so as to maintain proper spacing of the magnets. In this case the rings are hinged on a pin or shaft. The hinges can also consist of balls and sockets mounted on the sides of said brackets so that said EMATs conform to test component surfaces that are contoured in two dimensions.

FIG. 23 illustrates the use of springs, 25, installed at the top of each magnet. Said springs prevent the poles at the top of the magnets from coming together during service. Also, said springs help keep the poles, 26 at the bottoms of said magnets in close proximity to the EMAT coils with the axes of said coils aligned normal to test component surface. Alternately, the spacing at the top of the magnets can be implemented by an array of rings that are machined or molded in a configuration that fits the contour of test component. The spacers can be cut to proper length and attached, e.g. welded, to an adjacent ring at a predetermined angle that results in conformity of the magnet array to the test component surface. The array of spacers can be a flexible plastic sheet or silicon rubber mold that accommodated bending of the magnet array to the desired contour while keeping the proper spacing and alignment of said magnets.

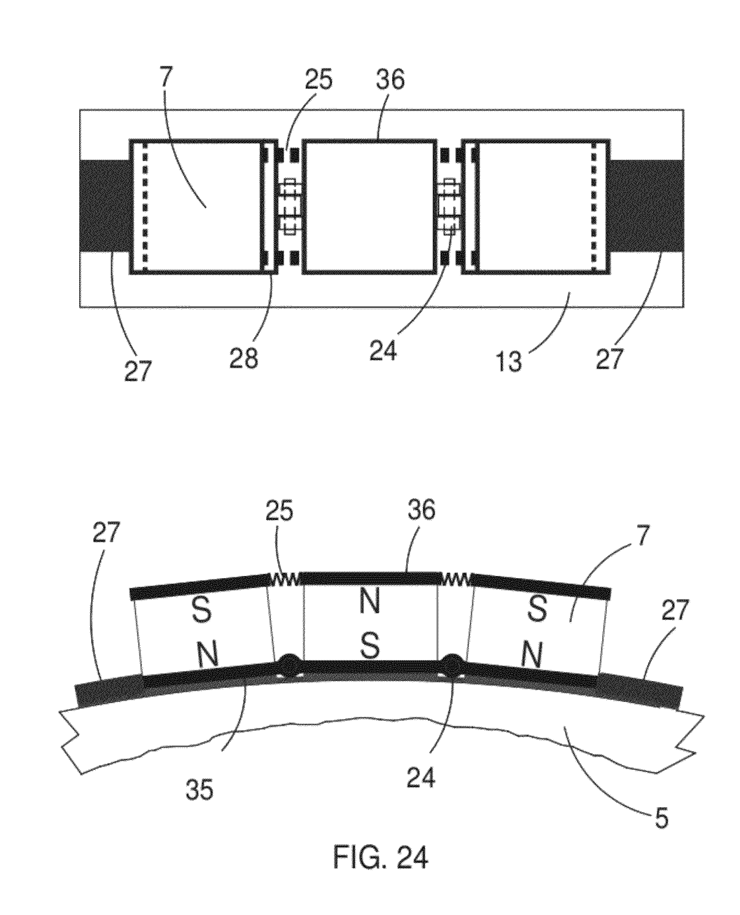

Said racetrack coils, said rectangular coils, said butterfly coils and said meander coils require the use of block magnets to provide a magnetic bias field that is centered over said coils. This is accomplished by the use of a chain of hinged brackets as illustrated in FIG. 24. Said brackets, 28, and hinges, 23, are installed near the base of the magnet poles that are close to said coils to maintain proper spacing of said magnets. In this case the brackets are hinged on a pin or shaft. The hinges can also consist of balls and sockets mounted on the sides of said brackets so that said EMATs conform to test component surfaces that are contoured in two dimensions.

Springs, 25, connected to the brackets, 36, are installed at the top of the magnets to prevent said magnets from coming together during service. Also, said springs help keep the bottom pole faces in close proximity to the EMAT coils with their axes aligned normal to test component surface. Alternately, the spacing at the top of the magnets can be maintained by an array of brackets that are machined or molded in a configuration that fits the contour of said test component. Said array of brackets can be cut to proper length and attached, e.g. welded, to an adjacent ring at a predetermined angle that results in conformity of the magnet array to the test component surface. Also, said array of brackets can be a flexible plastic sheet or silicon rubber mold that accommodates bending of the magnet array. Said array can be held in place by a belt, 27, that wraps around the pipe and over the EMATs whereby said belt is pulled in tension and held in place by fastening the ends of the belt to each other.

When said pipe is composed of ferromagnetic material, e.g. carbon steel, and permanent magnets are used, the magnets can provide sufficient normal and frictional force to hold the linear array of EMATs in place during the monitoring process. This effect can be enhanced by using materials that have a relatively high coefficient of friction for the insulating cover layers.

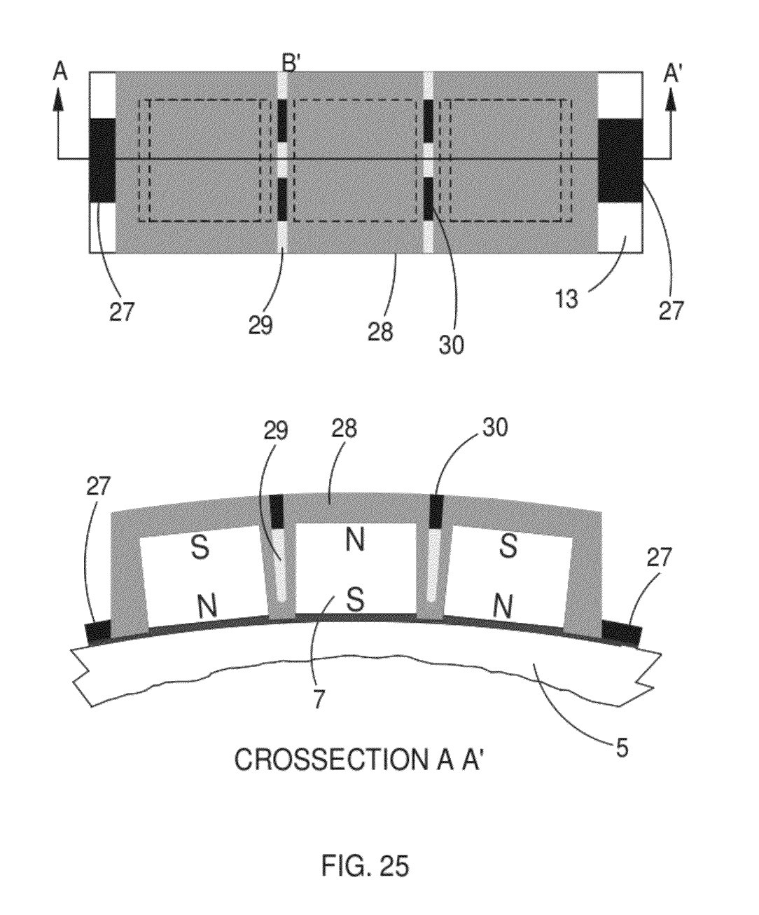

Another means for assembly of said cylinder magnets, block magnets and U-shaped magnets with proper separation and position over the EMAT coils is illustrated in FIG. 25. A flexible potting compound, 28, such as silicon rubber is applied to a mold that encases said magnets, 7, and is bonded to the top surface of the EMAT coil array. Compliancy to a curved surface provided by the flexible potting compound can be improved by molding or cutting slots, 29, in said potting compound and inserting springs or spacers, 30, of proper dimensions at the top of said magnets.

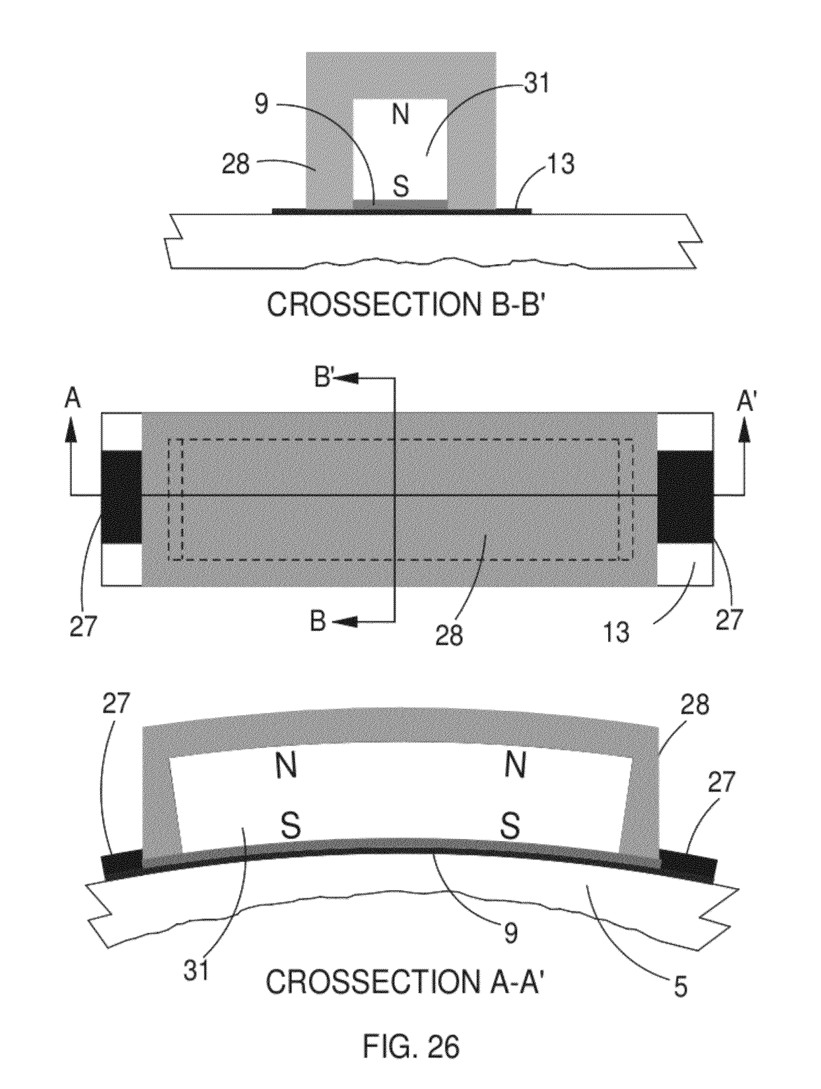

Overlapping EMAT coils require the use of an elongated, contoured block magnet, 31, as illustrated in FIG. 26. This block magnet produces a magnetic bias field that is perpendicular or normal to the surface of the test material so that overlapping coils are active during operation of the EMAT instrumentation. Crossection A-A′ depicts a magnet of rectangular section that provides a relatively uniform normal magnetic field of sufficient intensity to perform a reliable measurement of defect propagation. The magnet can be encased in a suitable potting compound, 28, for protection, cooling and adherence to the array of circular spiral coil EMATs. The elongated magnet can be fabricated as a single continuous unit or composed of several sections of block magnets.

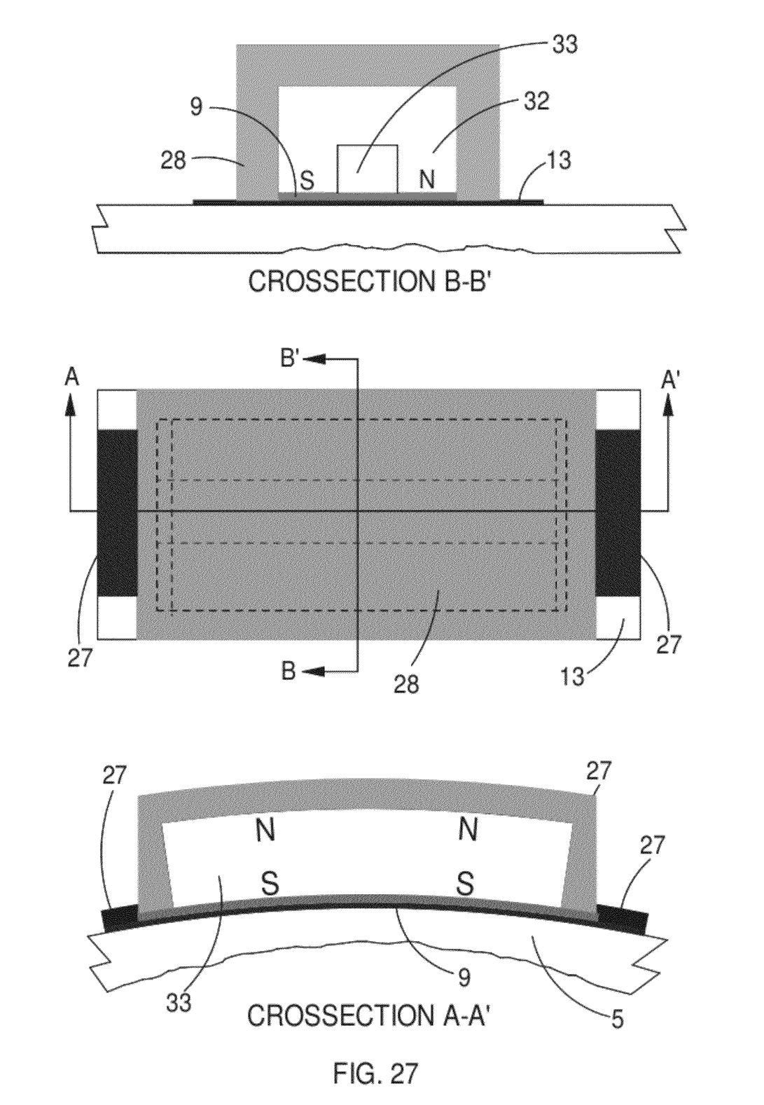

FIG. 27 illustrates an elongated, contoured, U-shaped magnet, 32. Said magnet has 2 poles that provide a return path for increased magnetic field intensity particularly when the test material is ferromagnetic. EMAT coils can be located under each of the magnet poles or in the gap, 33, between the poles. Said EMAT coils are placed in said gap the when the test material has magnetostriction properties or when said EMAT coil is designed for generation of longitudinal waves. The elongated magnet can be fabricated as a single continuous unit or composed of several sections of U-shaped magnets.

FIG. 27 illustrates an elongated, contoured, E-shaped magnet, 34. This magnet has 3 poles and provides a return path for increased magnetic field intensity particularly when the test material is ferromagnetic. EMAT coils can be located under each of the magnet poles or in the gaps, 34, between the poles when the test material has magnetostriction properties or the EMAT coil is designed for generation of longitudinal waves. The elongated magnet can be fabricated as a single continuous unit or composed of several sections of E-shaped magnets.

The linear array of circular spiral coils illustrated in FIG. 4 can be expanded into multiple rows to form a two-dimensional (2D) array. FIG. 13 illustrates a two-dimensional array chemically etched or machined, circular spiral coil EMATs for monitoring defects such as wastage corrosion and internal fissures in contoured metal components and structures. Conforming arrays of magnets illustrated in FIG. 6, FIG. 7, FIG. 9, FIG. 10 and FIG. 11 can be used with said 2D array of circular spiral coils when the test component is a cylinder such as a pipe. If the test component has curvature in two dimensions, linear arrays of magnets illustrated in FIG. 6 can be attached through hinges on all sides for compliancy to the test component surface. In this case a ball-and-socked hinge would be used. If said magnets are molded in a flexible material such as silicon rubber, slots can be machined on all sides of the brackets so that said EMATs conform to test component surfaces that are contoured in two dimensions.

A linear array of Lorentz EMATs is illustrated in FIG. 39. The printed circuit or etched coils, 9, are composed of two or more layers of conductors arranged in trapezoidal shaped spirals. Said layers are electrically connected by plated holes, 12, through the substrate. The overlapping pairs of electrical leads, 11, to each coil and are attached to the connector, 14. One of the poles of said two-pole magnet is placed between the straight sections of each of the rectangular coils in an area indicated by the dashed lines, 8.

The arrays of meander coils have a construction that is similar to the construction of circular spiral coils, illustrated in FIG. 5 and described in paragraphs 23, 24 and 25. The optional use of cover layers 16, 17, 20 and 21 are intended primarily to protect the coils and magnets from damage when the test component is at elevated temperatures. The composition and thickness of these cover layers can be selected according to the maximum temperatures to which the EMAT arrays will be exposed.

What is claimed:

1. Arrays of Electromagnetic Acoustic Transducers (EMAT) consisting of coils of electrical conductors and magnets arranged in various configurations and designed for durability, conformability and attachment to curved surfaces of metal components including but not limited to piping, pressure vessels and tanks operating at elevated temperatures as well as temperatures below ambient for the purpose of monitoring the extent and severity of defects including but not limited to corrosion, voids and cracks.

2. Arrays of EMATs as in claim 1 consisting of coils of electrical conductors fabricated by chemically etching or machining plated coatings of electrical conducting materials including but not limited to copper, silver and gold that are bonded to both surfaces of a flexible, electrically and thermally insulating substrate such as a polyimide or flexible ceramic whereby the coils are connected by plated holes through said substrate so as to cause the electrical currents in adjacent conductors on the same surface and on opposite surfaces of said substrate to flow in the same direction.

3. Arrays of EMATs as in claims 1 and 2 consisting of coils of electrical conductors that are bonded to both surfaces of an electrically and thermally insulating substrate where the ends of the coils that connect to the EMAT instrumentation are connected to parallel strips of conductors that are separated by and insulated from said substrate thereby forming a transmission line to the connector that exhibits decreased inductance and impedance compared to conventional coaxial and twinaxial cables.

4. Arrays of EMATs as in claims 1, 2, and 3 consisting of coils of electrical conductors that are bonded to both surfaces of a flexible, electrically and thermally insulating substrate whereby the coils that are to be in closest proximity to the test component under interrogation are covered with a flexible, electrical and thermal insulation including but not limited to polyamides and ceramics.

5. Arrays of EMATs as in claim 4 consisting of coils of electrical conductors that are bonded to both surfaces of a flexible, electrically and thermally insulating substrate whereby said coils that are in closest proximity to the test component are covered with a layer of electrical insulation, a layer of electrical conducting strips that are insulated from each other and a layer of electrical and thermal insulation over the conductor stripes.

6. Arrays of EMATs as in claim 4 consisting of coils of electrical conductors that are bonded to both surfaces of a flexible, electrically and thermally insulating substrate whereby the coils that are to be in closest proximity to the magnets are covered with a layer of electrical insulation, a layer of electrical conducting strips that are insulated from each other and a layer of electrical and thermal insulation over the conductor stripes.

7. Arrays of EMATs as in claims 5 and 6 consisting of coils of electrical conductors that are bonded to both surfaces of a flexible, electrically and thermally insulating substrate whereby the coils that are to be farthest from the component under interrogation are covered with electrical insulation and strips of electrical conductors that are attached to thicker and wider strips of electrical conductors at the ends of the coil arrays.

8. Arrays of EMATs as in claim 7 consisting of coils of electrical conductors that are bonded to both surfaces of a flexible, electrically and thermally insulating substrate where thicker and wider strips of electrical conductors connected to at the ends of the coil arrays are attached to heat exchangers such as heat pipes and thermoelectric (Peltier) coolers.

9. As in claims 1, 2, 3, 4, 5, 6, and 7 an array of two or more circular spiral coils arranged so that they are collinear to a line that fits the contour of test component and passes through the centers of said coils each having parallel-strip leads on either side of said insulating substrate that are arranged with the other pairs of strips connected to other coils in the array in a narrow band.

10. As in claims 1, 2, 3, 4, 5, 6, and 7 an array of two or more racetrack, spiral coils arranged so that they are collinear to a line that fits the contour of test component and passes through the centers of said coils each having parallel-strip leads on either side of said insulating substrate that are arranged in a narrow band with the pairs of other coils in the array.

11. As in claims 1, 2, 3, 4, 5, 6, and 7 an array of two or more rectangular, spiral coils arranged so that they are collinear to a line that fits the contour of test component and passes through the centers of said coils each having parallel-strip leads on either side of said insulating substrate that are arranged in a narrow band with the pairs conductors of adjacent said coils in the array.

12. As in claims 1, 2, 3, 4, 5, 6, and 7 an array of two or more butterfly coils, as illustrated in FIGS. 13 and 14, arranged so that they are collinear to a line that fits the contour of test component and passes through the centers of said coils each having parallel-strip leads on either side of said insulating substrate that are arranged in a narrow band with the pairs of other coils in the array.

13. As in claims 1, 2, 3, 4, 5, 6, and 7 an array of two or more meander coils, as illustrated in FIG. 15, arranged so that they are collinear to a line that fits the contour of test component and passes through the centers of said coils each having parallel-strip leads on either side of said insulating substrate that are arranged in a narrow band with the pairs conductors of adjacent said coils in the array.

14. As in claims 1, 2, 3, 4, 5, 6, and 7 an array of two or more trapezoidal spiral coils, as illustrated in FIG. 16, arranged so that they are collinear to a line that fits the contour of test component and passes through the centers of said coils each having parallel-strip leads on either side of said insulating substrate that are arranged in a narrow band with the pairs conductors of adjacent said coils in the array and said coils are placed under arrays of block magnets where said magnets have opposite polarity with respect to adjacent magnets and magnets can be positioned at an angle so that one side of said block magnet is approximately perpendicular to said coil conductors.

15. An array of cylindrical magnets, as illustrated in FIG. 23, that are installed in rings that are centered over the said spiral Coils and made of suitable material such as aluminum, brass and plastics that can withstand elevated temperatures and fastened to the magnets near the bottom of the magnet that is closest to the EMAT coil array and linked together with a hinge or flexible material attached to the rings of adjacent magnets in a line that conforms to the component under interrogation.

16. An array of block magnets, as illustrated in FIG. 24, that are installed in brackets that are centered over the said racetrack, spiral Coils and made of suitable material such as aluminum, brass and plastics that can withstand elevated temperatures and fastened to the magnets near the bottom of the magnet that is closest to the EMAT coil array and linked together with a hinge attached to the brackets of adjacent magnets in a line that conforms to the component under interrogation.

17. An array of cylindrical or block magnets that are encased in a mold with slots between the magnets, as illustrated in FIG. 25, so as to improve the flexibility of said array that is made of flexible material such as silicon rubber that can withstand elevated temperatures and are held in position so that the magnets are centered over the said spiral Coils and are arranged with their center axis in a line that conforms to the component under interrogation.

18. An array of circular spiral coils as in claims 1, 2, 3, 4, 5, 6, and 7 having two overlapping collinear arrays one on each side of the insulating substrate, where each said coil has a separate lead conductor on each side of the said substrate with one lead connected to the coil conductor on the greatest coil radius and the other lead connected through the plated hole on the minimum radius of the coil.

19. An array of racetrack spiral coils as in claims 1, 2, 3, 4, 5, 6, and 7 having two overlapping collinear arrays, one on each side of the insulating substrate, where each said coil has a separate lead conductor on each side of the said insulating substrate with one lead connected to the coil conductor located at the greatest distance from said coil center on the outside of said coil and the other lead connected through the plated hole in the said insulating substrate on the inside region of the coil.

20. An array of rectangular, spiral coils as in claims 1, 2, 3, 4, 5, 6, and 7 having two overlapping collinear arrays, one on each side of the insulating substrate, where each said coil has a separate lead conductor on each side of the said insulating substrate with one lead connected to the coil conductor located at the greatest distance from said coil center on the outside of said coil and the other lead connected through the plated hole in the said insulating substrate on the inside region of the coil.

21. An array of butterfly coils as in claims 1, 2, 3, 4, 5, 6, and 7 having two overlapping collinear arrays, one on each side of the insulating substrate, where each said coil has a separate lead conductor on each side of the said insulating substrate with one lead connected to the coil conductor located at the greatest distance from said coil center on the outside of said coil and the other lead connected through the plated hole in the said insulating substrate on the inside region of the coil.

22. An array of meander coils as in claims 1, 2, 3, 4, 5, 6, and 7 having two overlapping collinear arrays, one on each side of the insulating substrate, where each said coil has a separate lead conductor on each side of the said insulating substrate with one lead connected to the coil conductor located at the greatest distance from said coil center on the outside of said coil and the other lead connected through the plated hole in the said insulating substrate on the inside region of the coil.

23. Two arrays of meander coils, each as in claims 1, 2, 3, 4, 5, 6, where the arrays are collinear, as illustrated in FIG. 21, where two lines of coils are attached to separate but overlaying substrates so that each coil has two layers that are electrically connected through plated holes in the substrate and the two arrays of coils on their respective substrates are shifted laterally along the center line and electrically insulated from each other to form an increased density of EMATs.

24. A two pole magnet that has a rectangular-shaped crossection for use with a arrays of overlapping coils as illustrated in FIG. 17, FIG. 18, FIG. 19, FIG. 20, and FIG. 21 that is fabricated in a shape that conforms to the contour of the component under interrogation and provides magnetic fields at its poles that are approximately normal to the surface of said component and parallel to the axis of each said coil in the array.

25. A two pole U-shaped magnet for use with a arrays of overlapping coils as illustrated in FIG. 17, FIG. 18, FIG. 19, FIG. 20, and FIG. 21 that is fabricated in a shape that conforms to the contour of the component under interrogation and provides magnetic fields at its poles that are approximately normal to the surface of said component under interrogation and parallel to the axis of each said coil in the array.

26. A three pole E-shaped magnet for use with arrays of overlapping coils as illustrated in FIG. 17, FIG. 18, FIG. 19, FIG. 20, and FIG. 21 that is fabricated in a shape that conforms to the contour of the component under interrogation and provides a magnetic field at its poles that is approximately normal to the surface of said component under interrogation and parallel to the axis of each said coil in the array.

27. An arrangement of two or more linear arrays of circular spiral coils, as in claims 9 and 18 and cylinder magnets, as in claims 15 and 17 and contoured block magnets as in claim 24 and contoured U-shaped magnet as in claim 25 and contoured E-shaped magnets as in claim 26 to form a 2-dimensional (2D) arrays of EMATs that conform to the shape of the component under interrogation.

28. An arrangement of two or more linear arrays of racetrack spiral coils, as in claims 10 and 19 and block magnets, as in claims 16, and 17 and contoured block magnets as in claim 24 and contoured U-shaped magnet as in claim 25 and contoured E-shaped magnets as in claim 26 to form a 2-dimensional (2D) arrays of EMATs that conform to the shape of the component under interrogation.

29. An arrangement of two or more linear arrays of rectangular spiral coils, as in claims 11 and 20 and block magnets, as in claims 16, and 17 and contoured block magnets as in claim 24 and contoured U-shaped magnet as in claim 25 and contoured E-shaped magnets as in claim 26 to form 2-dimensional (2D) arrays of EMATs that conform to the shape of the component under interrogation.

30. An arrangement of two or more linear arrays of butterfly coils, as in claims 12 and 21 and block magnets, as in claims 16, and 17 and contoured block magnets as in claim 24 and contoured U-shaped magnet as in claim 25 and contoured E-shaped magnets as in claim 26 to form 2-dimensional (2D) arrays of EMATs that conform to the shape of the test component under interrogation.

31. An arrangement of two or more linear arrays of meander coils, as in claims 13 and 22 and block magnets, as in claims 19, 20 and 21 and contoured block magnets as in claim 17 and contoured U-shaped magnet as in claim 18 and contoured E-shaped magnets as in claim 19 to form a 2-dimensional (2D) arrays of EMATs that conform to the shape of the test component under interrogation.

32. An arrangement of two or more linear arrays of trapezoidal coils, as in claims 14 to form a 2-dimensional (2D) array of EMATs that conform to the shape of the test component under interrogation.
